(19) United States
(12) Patent Application Publication
(10) Pub. No.: US 2015/0199378 A1
(43) Pub. Date: Jul. 16, 2015

(54) METHOD AND APPARATUS FOR REALIZING A DYNAMICALLY TYPED FILE OR OBJECT SYSTEM ENABLING A USER TO PERFORM CALCULATIONS OVER THE FIELDS ASSOCIATED WITH THE FILES OR OBJECTS IN THE SYSTEM

(71) Applicant: Nick Alex Lieven REYNTJEN, Ledeberg (BE)

(72) Inventor: Nick Alex Lieven Reyntjens, Ledeberg (BE)

(21) Appl. No.: 14/408,350

(22) PCT Filed: Jul. 1, 2013
(86) PCT No.: PCT/EP2013/063821

§ 371 Date: Dec. 16, 2014

Related U.S. Application Data
(60) Provisional application No. 61/665,958, filed on Jun. 29, 2012.
(60) Provisional application No. 61/684,737, filed on Aug. 18, 2012.
(60) Provisional application No. 61/728,298, filed on Nov. 20, 2012.
(60) Provisional application No. 61/762,599, filed on Feb. 8, 2013.

(51) Int. Cl. G06F 17/30

(52) U.S. Cl. CPC G06F 17/30221

(57) ABSTRACT

According to the invention there is provided a method for retrieving the value of a first path of a first entity in a data system comprising a calculation device and a storage device with said first path stored thereon, said method comprising the step of said calculation device calculating said value as all calculated entities: that are descendants of said first entity; and that are members of said first path.

This application claims the benefit of
the provisional U.S. Patent Application with Ser. No. 61/665,958 filed Jun. 29, 2012 and
the provisional U.S. Patent Application with Ser. No. 61/684,737 filed Aug. 18, 2012 and
the provisional U.S. Patent Application with Ser. No. 61/728,298 filed Nov. 20, 2012 and
the provisional U.S. Patent Application with Ser. No. 61/762,599 filed Feb. 8, 2013
   which are incorporated by reference herein.

The terminology used in these provisional applications can be linked to the terminology used in this disclosure in the following way:
“Properties” are now called “fields”; and
A “membership property” is now called a “path”; and
“Root fields” are now called “primal fields”
“Calculated membership properties” are now called “derived fields”
“Generating fields” are now called “link paths”

### 1 TECHNICAL FIELD

This invention relates to a dynamically typed data system and method that enables a user to perform calculations over the information associated with files, documents, or other data entities stored in a non-transitory computer readable medium.

More particularly, the invention relates to a system and method that enables the user to perform calculations over “entities,” a term used to collectively refer to files, documents, programming objects or other data entities, arranged in “paths,” that identify for each appropriate entity a set of associated entities in that system, and have “attributes,” “sub-paths” and “references” to which we collectively refer to as the “fields” of a path.

The calculations performed by the invention enable derivation of both the fields that are applicable for an entity as well as their values. Note that paths are a specialized kind of field and their value is a set of entities for each appropriate entity.

The results of the calculations are output to a display or transmitted from one computer to another in order to provide the user with information concerning the entities within a path and information on that path itself, thereby allowing a “user,” whether in the form of a human or a computer process, to view information concerning the configuration and content of paths or other fields without having to take further action.

In addition to this, the invention is related to the fields of databases, spreadsheets and reactive programming in general and compiler techniques because paths with attributes resemble tables; calculations over fixed ranges resemble the typical calculations found back in spreadsheets; and the formulas by which users can configure the system should be analysed, validated and compiled into other forms before they can be used in calculations. In addition to this, the invention is related to the field of algebra and more particularly formula transformations.

### 2 BACKGROUND ART

2.1 References to Prior Art

This invention extends the invention disclosed in the U.S. patent application Ser. No. 13/736,646 filed Jan. 8, 2013 which is incorporated by reference.

2.2 Description of Prior Art

While conventional file systems associate some attributes with their files such as the filename, size and format, they generally do not support creating additional attributes; aggregating over attributes; calculating the visual display state of multiple attribute with one formula; calculating the value of attributes and the content of folders through associated formulas that behave polymorphically and are self-updating in response to changing input; linking files together in links and attaching information to those links; files that can reside in multiple folders at the same time and files that are associated with multiple child files that are categorized in multiple folders. Similarly, while conventional spreadsheets support aggregations over fixed ranges of cells, they generally do not support aggregating over dynamic ranges of cells; aggregating over a subset of rows or columns; aggregating over cells of multiple spreadsheets; being associated with multiple parent and child spreadsheets; sharing formulas with other spreadsheets or having cells whose formulas behave polymorphically. Lastly, while databases support creating classes of entities with attributes and links between them, they generally do not support polymorphic attributes; entities that have a dynamic amount of attributes; entities with polymorphic behaviour that changes over their lifetime; calculations that are self-updating in response to changing input; defining attributes on links; allowing navigating to linked entities without specifying joins; deep-inheritance, deep polymorphism and deep type inference; inferred inheritance or incremental type checking.

In general, the current systems have no means to enable lay men to perform “complex” calculations on data, nor do they permit the results to be viewed in higher levels, for example realized by a hierarchical file, object storage or spreadsheet system.

The attributes in conventional file systems are in general not renamable. For example, the attributes named “Name”, “Size” and “Type” in windows explorer of windows 7, cannot be renamed by the user to, for instance, “myName”, “mySize” or “myType”.

By contrast, in this invention attributes are preferably “renamable”, and more preferably “renamable at runtime”, meaning that in a multi-user embodiment of the current system, when two users are logged in, the first user can rename an attribute inside the system so that the second user can see the new name of the attribute without requiring him or her to log in again. It is presumed that users that rename an attribute have the correct credentials to do so. Alternatively we may say that an attribute or field has a human readable identifier, e.g. its name, which is modifiable.

### 3 SUMMARY OF INVENTION

### 3.1 Technical Problem

This invention provides a solution for data systems that need to manage complex data. By providing technical solutions to higher data structuring features, data systems can be built with less bugs, accelerated speed, greater flexibility and a greater capability of predicting the user's desires which allows us, for example, to suggest formulas to the user. These positive technical effects are realized by reaching a higher understanding of the semantics of the user's data, that is: the computer ‘understands’ better what a user is saying. An extreme increase in user friendliness is also one of the technical effects. To illustrate, an application like the one depicted in FIG. 43, which is intended to be none limiting, can be built in a few minutes. This is not feasible in conventional spreadsheets or databases.

Semantics is a broad and intangible word, yet it is crucial to the design of data system. For this reason we take the reader on a journey of semantics in the next section so that he or she can get a feel of what is intended by this and where the problems lie in the prior art. The best definition that the author can give of semantics is the following: “The ability to augment a certain amount of explicit information with implicit information that captures regularities that where not explicitly present in the explicit information”. In essence this is what humans are so good at, we see information, e.g. a burning fire, and augment that information with knowledge in our head, e.g. dangerous. Data systems that do higher semantical interpretation of the input, require less code, in order to achieve the same result, since a larger amount of information, that is code, can be deducted. In other words, less code can do more! Hence, the code required to configure these systems will always be smaller than the code required to configure a system with the same behaviour but less semantical deduction capabilities. Hence, a system that has higher semantical capability than another system, will have the technical effects of reduced memory consumption, fits better into the CPU cache and thus is faster and vast a reduction of bugs. Additionally, the constraints implicitly present in the data of these systems are more explicitly understood by the system which allows it to perform its calculation in a more parallel and concurrent way.

### 3.1.1 Higher Semantics

The invention solves many modelling problems found back in the prior art. In order for the reader to get a feeling of modelling challenges that create problems in current widespread modelling approaches, this section has been created.

The semantic and modelling issues mentioned in this section will serve as a mental guideline throughout the rest of the documents and it will let those skilled in the art understand why certain design choices have been made, what there semantic basis is and how they affect system performance.

The rest of this section is very informal, slightly incorrect, and deliberately does not accurately describe the invention. It allows the author to give the reader a ‘feel’ of the problem, without overwhelming him or her with too in many details or with examples that are too abstract to be easily understood. The actual discloser can be found in the section 6, called “Description of the embodiments”; more specifically, it will be appreciated that the invention is not to be limited to any of the informal examples provided in this section, but rather should be limited solely by the appended claims. This section's purpose is to give the reader a frame of thinking to which he or she can hold onto when reading the full discloser. Notations of fictional languages are improvised and not every detail of them is explained but those skilled in the art will be able to interpret them, as it is normal for programmers to be able to correctly interpret computer languages that are new to them.

To be able to clearly follow the discloser of the invention, it may be useful to have a brief discussion about the semantics of data. More particularly how we, as humans perceive the world, communicate and model information systems that reflect how we perceive the world and communicate.

Currently the mostly widespread technique used to model the world is by using statically typed object oriented (OO) structures. For instance, a computer system that would like to model information about stores that sell cars might have the following types:

class CarDealer { string name; List<Car> cars; }
class Car { string serialnumber; int price; }

This example says the following to a computer;
there is a thing, called a CarDealer, and that thing has a name, being a series of characters, and a list of Car and
a Car is a thing that has a serialnumber, being a series of characters, and a price, being a numeric value.

The model can also easily be represented in a relational database (e.g. MsAccess).

But now suppose that car dealers deal in different kinds of cars, and for each kind of car we would like to store different information. We alter the example like this:

class CarDealer { string name; Set< Car > cars; }
abstract class Car { string serialnumber; int price; }
class SUV : Car { bool hasFourWheelDrive; }
class SportCar : Car { int maximumSpeed; }

The example now says the following to a computer;
There is a thing, called a CarDealer, and that thing has a name, a series of characters, and a list of Cars and
a Car is a thing that has a serialnumber, a series of characters, and a price, a numeric value and
a SUV is a Car, therefore it has all fields that a Car has, but on top of that is has a field hasFourWheelDrive, with a boolean value, likewise
a SportsCar is a Car, therefore it has all fields that a Car has, but on top of that is has a field maximumSpeed, with a numeric value.

The technique that we applied here is called inheritance, e.g. “SportCar:Car” means sport car inherits all attributes from car. Relational databases lack this feature; therefore modelling this kind of information in them already becomes troublesome.

In traditional statically typed systems, objects cannot change their type, nor can an object be of two types at the same time. These may seem like an odd features at first, yet extending the given example a bit further will illustrate when these situations occur.

Suppose the car dealer also deals in second hand cars. When a car is second hand we want to store the name of the previous owner, their address and telephone number. We can start thinking like a data designer and conclude that we can solve this by creating a new type that no longer maps to a physical object, SecondHandInfo, and is referenced too by car objects, for example:

```
class CarDealer { string name; Set< Car > cars; }
class  SecondHandInfo  {  string  name;  string
            address; string telephoneNumber; }
class  Car  {  string  serialnumber;  int
        price; SecondHandInfo secondHandInfo; }
class SUV: Car { bool hasFourWheelDrive; }
class SportCar : Car { int maximumSpeed; }
```

A much more elegant solution would be:

class CarDealer { string name; Set< Car > cars; }
class Car { string serialnumber;
int price; bool isSecondHand; }
When (Car.isSecondHand) {
string previousowner_name;
string previousowner_address;
string previousowner_telephoneNumber;
class SUV: Car { bool hasFourWheelDrive; }
class SportCar : Car { int maximumSpeed; }
(*) Fictional code, no language currently supports this

The reason why it is more elegant is that it maps much closer to how we expressed what is needed in the first place: ‘When a car is second hand we want to store the name of the previous owner, their address and telephone number’. This new language is closer to how we naturally speak and think, answer, and fill in forms and questionnaires; and therefore is easier to understand and use. This is because it allows us to state the problem instead of solving it. Those who are skilled in the art will recognize how this in essence embodies wizard building functionally.

What we see is that the presence of certain attributes of a car depends on the values of other attributes of that car; if the ‘isSecondHand’ attribute is true, than the car instance gets 3 extra fields:

- previousowner_name,
- previousowner_address and
- prewousowner_telephoneNumber.

These fields are volatile and the fact that a car can be both a member of the Car and of the SecondHand classes, is called multi-membership. This corresponds to how an object can dynamically become of a certain type in the disclosed invention, in this case being ‘Secondhand’. Other non-related example include: A person can become a women, a dog can become injured, a car can become stolen, an invoice can become paid, a task can become due, etc.

This illustrates a case of multi-memberships and volatile fields, and its technical effects includes
Faster performance, reduced memory leaks and less storage. This is because the computer knows that second hand info is not shared between cars, so it can store second hand info directly on the car instance
   making retrieval of second hand info faster since it does not require a second look-up and
   preventing memory leaks since it knows that if a car ceases to exists so does its second hand info so it is not needed for the user to perform error-prone clean-up actions such as cascade delete or memory de-allocation and
   making the storage of second hand info smaller, since no pointer is required to point to the second hand info.
Increased flexibility since objects can be an instance of multiple classes at the same time. For instance, in a model for medical organizations wherein a person can be diabetic, septic and obese all at the same time, it would require 8=2̂3 classes to represent all combinations. The ability for an object to be an instance of multiple classes at the same time reduces the amount of needed classes by an exponential factor.
Decreases maintenance costs, lowers complexity, leads to a vast reduction of bugs and faster development times, because the code can more accurately describe what the user intended.

This illustrates how a computer gets a higher level of understanding of what the user intended. Those skilled in the art will appreciate that the user could of course just have defined the attributes

- previousowner_name,
- previousowner_address and
- previousowner_telephoneNumber

on Car itself, but this would result in a waste of memory and a greater chance of bugs, since the user would have access to the value of one of those attributes when the car is not second hand, which would be a logical error since those attributes do not exist on cars that are not second hand. The type inference engine prevents these and other logical errors.

The fact that objects dynamically become an instance of multiple types at the same time, can be seen as the system asking different questions in response the user supplying different answers to previous questions. Note that this is also how conversation and questionnaires are performed, based on the already received information we ask for different questions:

```
1) Person1: I bought a pet yesterday.
2) Person2: What kind of pet?
3) Person1: A tarantula.
4)  Person2:  Do  you  keep  him  in  an
aquarium?
    -> Would not make sense if statement 3 was: “A dog.”
5) Person1: yes.
6) Person2: A big one?
  ->  Would  not  make  sense  if  statement  5  was:
    “No,  he's loose in the house.“
....  and  so  on.
```

This corresponds to a kind of ‘self-building wizards’ and illustrates how this results in a system where the computer only asks questions that make sense given the current context. For example, when an outstanding invoice becomes a defaulted invoice it makes sense to ask if the case should be handed over to the legal department. If the invoice is paid, it does not. Again, the system gains better understanding of the problem. As we will later see this feature is called inter-life-time polymorphism and it allows for much more flexible systems. It also allows for a very natural place to perform actions, for instance sending an email when a person becomes retired and lends itself naturally to support workflow.

Also how objects relate to each other changes: A friend may become a lover. An Employee may become a fired Employee or CEO. Therefore not only objects but also associations can be an instance of multiple classes at the same time.

In essence we can say that the only data that an association has is the two objects that it associates. So, instead of saying “Ann is the employee of Stef”. We say “Ann and Stef are associated somehow”, and later we add the information that the association is an employment. Later we may also add, that association is also a Friendship. This is an example of link instance unification. Besides allowing users to view relationships in their entire context, link instance unification requires less memory space, since only one entity is required to store multiple relationships. And it allows for much stronger forms of polymorphism and more optimized indexing. For Employments and Friendships we would store different information. The fact that an association is a Employment would imply certain attributes, that is, questions that make sense given the information that it is a Employment, for example ‘salary’ could be such an attribute.

One of the higher level structural features that is built into the system is that of containment. Semantically, the apartments of a building are a part of that building. A mental proof of this is the fact that if a building would have never existed, neither would its apartments. We say that the apartments of a building are contained by value. When the building ceases to exists, so do its apartments. Later we will see that this situation corresponds to atomic paths. In contrast to this is the relationship between persons and companies, that is, the employees of a company. The persons employed by a company do not cease to exist when the company ceases to exist, but the relationship between them, the employments, do. We say that the employees of a company are contained by reference and later we will see that this corresponds to link paths.

Let's alter the example a bit; so that cars can be damaged and when a car is damaged, it has damages.

class CarDealer { string name; List< Car > cars; }
class Car { string serialnumber; int
price; bool isDamaged; }
When (Car.isDamaged) { Set<Damage> damages; }
class Damage { string description; }

To increase the semantics of this model, let us alter its notation so that we can give a name to a car that has been damaged, let's call it a damaged car:

```
class CarDealer { string name; List< Car > cars; }
class  Car  {  string  serialnumber;  int
      price; bool isDamaged; }
class  DamagedCar(Cars  where
Car.isDamaged) {
    Set<Damage> damages; }
class Damage { string description; }
```

The damages of a car are contained by-value, yet the computer would not know this from the current code. So let us invent a notation that allows the computer to understand this, for example:

class CarDealer { string name; Set< Car > cars; }
class Car { string serialnumber; int price;
bool isDamaged; }
class DamagedCar(Cars where
Car.isDamaged)
{ Set<class { string description; }> Damages; }

As we will later see, Damages is a by-value typed collection of DamagedCars, which means that the class Damage is defined inline. In C++ we would note this as:

struct DamagedCar {
struct Damage { string description; } *Damages;
};

In this C++ notation, we need to specify the name of the class Damage separate from the name of the list Damages, and special care should be taken to ensure that the memory assigned to a Damages pointer is released in response to deleting the corresponding DamagedCar object. By-value typed collection resolves both of these issues.

The technical advantages of by-value typed collection is that no secondary lookups are required to retrieve the Damages of a car, and no cascade deletes or memory de-allocation need to be configured by the user, preventing memory leaks. A further advantage is that less code is required because no reference to a class need to be made, the class and the collection consisting out of instances of that class are the same thing, allowing the meta-data of such application to be stored in less space and improving maintainability.

But we can apply this pattern further when we say that the cars and the car dealers of the system, are cars and car dealers of worlds in the system and when such a world is deleted, so are its Cars and Cardealers. We get:

```
Set<class {
      Set<class {
            string name;
            Set<Car>  cars;  //  By-reference
      }> CarDealers;
      Set<class {
            string serialnumber;
            int price;
            bool isDamaged; }> Cars;
      Set<class {
            Set<class { string description; }> Damages;
      }>  DamagedCars(Cars  where  Car.isDamaged);
}> Worlds;
```

We call these new, nested, classes paths. So Worlds is a path, and so is CarDealers and so is CARS and so is DamagedCars. We often want to write down these path in a way to makes their containment explicit is path notation:

/WORLDS/CARDEALERS/CARS
/WORLDS/CARS
/WORLDS/DAMAGEDCARS

We include the attribute in this path notation we get:

/WORLDS/CARDEALERS/CARS
/WORLDS/CARS
/WORLDS/CARS/SERIALNUMBER
/WORLDS/CARS/PRICE
/WORLDS/CARS/ISDAMAGED
/WORLDS/DAMAGEDCARS
/WORLDS/DAMAGEDCARS/DESCRIPTION

Note how path notation can be read from left to right, by use of the words ‘every’ and ‘has’, to quite accurately describe the model:

- every WORLD has CARDEALERS
- every CARDEALERS has CARS
- every WORLD has CARS
- every CAR has a SERIALNUMBER
- every CAR has a PRICE
- every CAR has a ISDAMAGED
- every WORLD has DAMAGEDCARS
- every DAMAGEDCAR has a DESCRIPTION

Note how the function of a path is twofold:
one the one hand it is like a class in OO, since it has attributes, e.g. PRICE is an attribute of CARS.
one the other hand it is like a method in OO, since it has a value, e.g. a WORLD has CARS would the modelled in conventional OO as a class WORLD with a method “GetCars( )”

Hence a path is both
a structured type, something that has structure, e.g. its fields and
a field, something that has a value given a subject.

This is very unconventional, feels weird to the normal programmer and leads to much confusion. It should be kept in mind all time. When comparing path to classes in OO, a path has both the functions of a class and a method.

We can extend the model even further and say that a damaged car may be caused by an accident, and when it is, we would like to store ‘is_covered_by_insurance’ for each Damage:

```
Set<class {
      Set<class {
            string name;
```

| | |
|---|---|
| Set<Car> cars; // | By-reference |

```
      }>  CarDealers;
      Set<class {
            string serialnumber;
            int price;
            bool isDamaged; }> Cars;
      Set<class {
            Set<class { string description; }>  Damages;
```

| | |
|---|---|
| bool | causedByAccident; |

| | |
|---|---|
| }> DamagedCars(Cars where | Car.isDamaged); |

```
      Set<class {
            Set<class {
```

| | |
|---|---|
| bool | is_covered_by_insurance; |

} > Damages : DamagedCars/Damages;

| | |
|---|---|
| }> DamagedCarsCausedByAccident : | DamagedCars |

(DamagedCars where DamagedCar.causedByAccident);
}> Worlds;

The result of this is that the Damages of damaged cars that are caused by an accident, are both instances of
the Damages defined under DamagedCars,
   e.g. Worlds/DamagedCars/Damages, and
the Damages defined under DamagedCarsCausedByAccident,
   e.g. Worlds/DamagedCarsCausedByAccident/Damages.

Since Worlds/DamagedCarsCausedByAccident/Damages has an attribute “is_covered_by_insurance”, all of those damages will have the attribute “is_covered_by_insurance”.

This is an example of super-positioned memberships. Notice how DamagedCarCausedByAccident inherits DamagedCar, this is the result of formula inheritance. The technical features include the automatic generation of inferred fields, which on their turn provides part of a typing system that reduces greatly the chance of bugs and makes the system much less error-prone to adaptation and much more flexible. Deep inheritance has similar advantages for similar reasons, the main one being able to aid the user much more by inferring which attributes he can use in formulas at which point in his model. And thus allowing the system to suggest formulas. These features together increase the semantical understanding that the computer has of the users' model.

If in the last example, if we
denote the name of a class in its plural form,
rename world to dataset,
no longer write the keyword class,
write the names of classes and attribute in upper case,
omit the curly brackets and
omit writing the type of the attributes
   we get something that is already very close to the path notation used in the other parts of the disclosure:

```
DATASETS/
      CARDEALERS/
            NAME;
            CARS/
      CARS/
            SERIALNUMBER;
            PRICE;
            IS_DAMAGED;
```

| | |
|---|---|
| DAMAGED_CARS(Cars where Car.IS_DAMAGED) | / |

```
  CAUSED_BY_ACCIDENT;
      DAMAGES/
            DESCRIPTION;
```

| | |
|---|---|
| DAMAGED_CARS_CAUSED_BY_ACCIDENT: | DAMAGED_CARS |
| (DamagedCars | where |

```
        DamagedCar.CAUSED_BY_ACCIDENT)
        DAMAGES/
        IS_COVERED_BY_INSURANCE
```

In path notation we get:

```
/DATASETS/CARDEALERS/NAME
/DATASETS/CARDEALERS/CARS
/DATASETS/CARS/SERIALNUMBER
/DATASETS/CARS/PRICE
/DATASETS/CARS/ISDAMAGED
/DATASETS/DAMAGED_CARS  =  WHERE(CARS,  C  ->
C.ISDAMAGED)
/DATASETS/DAMAGED_CARS/CAUSED_BY_ACCIDENT
/DATASETS/DAMAGED_CARS/DAMAGES/DESCRIPTION
/DATASETS/DAMAGED_CARS_CAUSED_BY_ACCIDENT =
          Where(DAMAGED_CARS,
            DC  ->
            DC.CAUSED_BY_ACCIDENT)
/DATASETS/DAMAGED_CARS_CAUSED_BY_ACCIDENT/
DAMAGES/IS_COVERED_BY_INSURANCE
```

When reading the entire document, the missing information in this model, a better way to denote it and its full semantics will be fully explained.

Lastly, we have explained to the computer that car dealers have cars, from this the computer can immediately deduct that cars must also have an associate car dealer and the computer will generate an inverse field called back-link paths, in order to let the user access the car dealer associated with a car. By doing this in an automated way, again the system is made more flexible and less error-prone.

Those skilled in the art will see that besides a higher semantical understanding of the computer—which enables it to better locate potential bugs and retrieve information with less effort—the integration of the file system, a feature called file system exposability, makes the system more flexible by allowing the user to easily extract information from files, or inject information into files. This last feature is called document template instantiation. Unlike conventional template instantiation engines, this invention allows the user to inject values that are calculated by higher forms of polymorphism and thus has all of its implied technical effects. In addition to this, it also makes the storage requirements of systems that require both files and records to be stored smaller, since the files can reuse the hierarchy introduced by the records.

Those skilled in the art will appreciate that higher forms of polymorphism such as double dispatch, inter-life-time polymorphism and deep polymorphism not only make the system more flexible and less error-prone, but also reduce the amount of hard coded if statements in the system and thus make the code of an application smaller, and thus also faster since it will fit better into the local cache of CPU's. More information can be found on the internet, e.g. http://sourcemaking.com/refactoring/replace-conditional-with-polymorphism or http://www.google.be/#safe=off&sclient=psy-ab&q=polymorphism+vs+conditional+logic.

Those skilled in the art will further appreciate that features such as declarative calculated values and formula-writeback extremely reduce the amount of code that a system requires to maintain the intended variants, e.g. a formula that combines N attributes would conventionally require N snippets of code, and therefore not only make the application less error-prone, but also smaller and thus faster because it has a higher chance of fitting into the CPU cache of computing devices.

Those skilled in the art will further appreciate that formula suggestion extremely reduces the required development time to produce applications by reducing the amount of bugs that users are likely to introduce into applications.

Those skilled in the art will further appreciate that union, intersection and link typing further increase the semantical understanding that a computer has of a model of a user and allows for stronger type checking and thus for less error-prone code.

Those skilled in the art will further appreciate that implementation data sharing allows for a much more flexible scenarios of how conventional polymorphism works, as well as a reduction of memory required to store all the values of multiple implementations of a field, since their values can be shared.

Those skilled in the art will further appreciate that value entitization groups entities, but in contrary to conventional grouping, such as in SQL for instance, the user can attach information to each group by adding attributes to the path that is doing the entitization. This makes the system much more flexible and allows features such as polymorphism and inheritance to be applied to groups, making the system less error-prone and reducing code size and thus making the program faster because of the increased chance of fitting in the CPU cache of calculation devices.

Those skilled in the art will further appreciate that spreadsheet mapping, 2D mapping and table mapping in effect extends spreadsheets, 2D grid visualizations and tables with technical features such as of deep polymorphism, value implementation sharing, etc. and thus have all of their technical benefits, such as increased flexibility, reduced memory consumption and increase performance.

To those skilled in the art, the advantages over spreadsheets will be obvious; spreadsheet cannot realize structured by-value collection, polymorphism and so forth. In particular, solving some of the examples provided in spreadsheets will require duplication of formulas, commonly performed by dragging a formula in a cell in a horizontal or vertical manner. These duplications not only consume more storage, but more importantly are a major cause of bugs. Because the disclosed invention does not have the duplication of formula it will occupy less space, have less bugs and be more performance since the formulas that are stored can be more optimized to operate on data in a parallel manner.

The advantages over relational databases include among other things, not having to do joins, which not only is faster but it also reduces the ‘code’ size and thus make the application faster since it will better fit in the CPU cache when executed on a calculation device. Additionally, entities can be in multiple tables at once, which reduces the amount of needed pointers, and thus storage requirements.

### 3.1.2 Overview of Some of the Technical Features of the Invention that Lead to Higher Semantics, which Lead to a Reduction of Errors and Memory Consumption and Differentiates the Invention from the Prior Art

A summary of the features that are explained in the section “description of embodiments” and lead to a higher semantical understanding of the user's data by a computing unit, and thus a better performance and a reduction of bugs, are provided in in section 5.1.25, called “OVERVIEW OF SOME OF THE TECHNICAL FEATURES OF THE INVENTION”.

### 3.2 Solution to Problem

The invention relates to a system and method that enables the user to perform calculations over entities arranged in “paths”. Paths are arranged in a tree structure and each path, except the “root path”, has one “parent path” and potentially several “child paths”, also “sub-paths”.

As an example, in FIG. 1 which is intended to be non-limiting, PATH 2 is a child path of PATH 1. We may also say that PATH 2 is “defined on”, or alternatively “defined under”, PATH 1. A folder from a conventional file system would be an additional example of such path. In path-notation the paths in FIG. 1 are written as:

/PATH1
/PATH1/PATH2
/PATH1/PATH3
/PATH1/PATH3/PATH4

Wherein the parent path of PATH 2 is PATH 1 and the child paths of PATH 1 are paths PATH 2 and PATH 3.

Each path identifies a set of entities, called the “extent” of that path. The files under a folder of a conventional file system are an example of such an extent. When an entity is an element of the extent of a path, we say that said entity is a “member” of said path. Alternatively, we may also say that said entity is an “instance of” said path. As an example, in FIG. 1, ENTITY 2 is a member of PATH 2 and ENTITY 3 is a member of PATH 3 and the extent of PATH 2 is ENTITY 2. Would ENTITY 4 also have been a member of PATH 2, than the extent of PATH 2 would have been ENTITY 2 and ENTITY 4, and ENTITY 2 and ENTITY 4 would have been instance of PATH 2.

In the preferred embodiment of the invention, each entity has multiple “parent entities” and “child entities” which form an acyclic directed graph with a single “root entity”, called a “data-set”. In FIG. 1, ENTITY 1 is a root entity and all entities together are a data-set. Further, ENTITY 3 is a child entity of ENTITY 2 and ENTITY 1 is a parent entity of ENTITY 4.

Note that, in the preferred embodiment, both paths and entities have parents, the difference between them is:
a path may only have one parent
an entity may have more than one parent
every parent of a path is a path
every parent of an entity is an entity

Informally, we can say that path roughly corresponds to a class, and an entity to an object, in an object oriented system. That is,
paths are part of the meta level of the system, while entities are part of the data level of the system and
paths gives structure to the data.

The “ancestors” of a path are the recursive parents of said path and the “ancestors” of an entity are the recursive parents of said entity, similarity the “descendent” entities and path of a path or an entity are their recursive children. In FIG. 1, the ancestors of ENTITY 3 are ENTITY 1 and ENTITY 2 and the ancestors paths of PATH 4 are PATH 3 and PATH 1. Further, the descendants of ENTITY 1 are ENTITY 2, ENTITY 3 and ENTITY 4 and the descendants of PATH 1 are PATH 2, PATH 3 and PATH 4.

The invention enhances paths by allowing entities contained by them to form such acyclic directed graphs, but embodiments may still support conventional paths. In the remainder of this description, when referring to the word “path”, we are referring to enhanced paths unless explicitly mentioned otherwise.

In such a graph, every entity that is a member of a path A, preferably has at least one ancestor that is a member of the parent path of path A. Arrangements that meet this requirement are referred to as “ancestor-entity-in-parent-path-arrangements”. FIG. 1 shows an example that forms an ancestor-entity-in-parent-path-arrangement. Making ENTITY 4 a member of PATH 4 would cause it to no longer form an ancestor-entity-in-parent-path-arrangement, since ENTITY 4 does not have an ancestor that is a member of the parent path of PATH 4, said parent path being PATH 3.

A path is a field whose “value” for an entity is the descendent entities of said entity that are members of said path. As an example, in FIG. 1 the value of PATH 3 of ENTITY 1 is ENTITY 3, because ENTITY 3 is both a descendent of ENTITY 1 and a member of PATH 3. Similarly, ENTITY2 is the value of PATH2 for ENTITY1.

The “subjects” of a field are the members of the path under which said field is defined. As an example, in FIG. 1 ENTITY 1 is a subject of PATH 2, since ENTITY 1 is a member of the path on which PATH 2 is defined, being PATH 1. In said preferred embodiment, each field has one associated value for each of its subjects.

We define a “structured type” as anything that has fields, and a “field” as anything that has a value for each of its subjects. So it is correct to say that a path is both a structured type and a field. In FIG. 1, we see how PATH 3
has a value for its subject ENTITY 1, being ENTITY 3 and
has a field, being PATH 4

Entities under the root path do not have associated parent entities and in all further text special clauses to deal with this exception are implicitly implied and can be easily derived by the reader. The root path in FIG. 1 is PATH1.

According to one preferred embodiment, each path may have, in addition to sub-paths, attributes as fields. Both the attributes and sub-paths of a path are referred to as the fields of a path. Additionally, preferred embodiments allow these attributes and sub-paths to be inherited from other paths.

Different kinds of values exist, e.g. boolean, numeric, textual values, and file leading to different kinds of attributes, e.g. boolean, numerical, textual and file attributes. Those skilled in the art will appreciate that the value of file attributes is a BLOB, similar to BLOB columns in conventional databases.

According to at least one preferred embodiment of the invention, entities may be a member of multiple paths at the same time, enabling a feature called “multi-memberships”. The paths of which an entity is a member are called the “current paths” of that entity. From the current paths of an entity we can derive the “current fields,” the set of fields to which that entity is a subject, by calculating the union of the fields of those current paths. Fields that are not always current, are called “volatile fields”. Those skilled in the art will appreciate that both the number of current fields as well as their behaviour is influenced by the current paths of an entity. In preferred embodiments, the visual display state of GUI widgets that are associated with such volatile fields depends on whether they are current.

In at least one preferred embodiment, the values of attributes or sub-paths for their subjects can be, in addition to being inputted by the user, derived through calculations. To specify how the system should perform these calculations he can configure the system through a user interface or by associating formulas, possibly generated by the user interface, with these attributes and sub-paths. Those skilled in the art will appreciate that some embodiments may automatically recalculate the value of an attribute or sub-path in response to one of its calculation inputs changing, similar to spreadsheets, while others may recalculate the value of that attribute when it value is requested, similar to conventional databases.

Further, some paths in at least one preferred embodiment may uphold the constraint that each member has a second parent in addition to the first parent and that this second parent is an element of a predetermined, possibly by a formula calculated, set of entities for each subject called the “formula targets” of that path for that subject.

In addition to sub-paths and attributes the preferred embodiment may have a third kind of fields called “references”. References are built-in fields that allow the user to refer to ancestors of an entity or a combination thereof in formulas. The primary kinds of references are; “parent”, “left parent”, “right parent” and “root”.

In at least one preferred embodiment, the content of an entity can be accessed by a file attribute possibly named ‘file’, whose value can be derived through calculation or used to derive the value of other attributes. Some embodiments may allow the users to define additional file attributes or they may simply not associate a file with an entity or associate an empty file with an entity, reducing the system to a special kind of an object database.

In the preferred embodiment, actions may be automatically executed in response to an entity entering or exiting the extent of a path or in response to a change in the value of an attribute. These actions may execute arbitrary code, similar to stored procedures and triggers in databases. Examples of possible actions include sending an email, SMS, XML, SQL or other electronic message to a, potentially calculated, address with the appropriate, potentially calculated message parts such as body, subject, etc. Further examples of such actions include incrementing, copying, assigning or otherwise altering the value of an attribute, creating a new entity, instantiating a template, or printing the file associated with an entity.

In the preferred embodiment, the attributes of paths may be associated with a cell location in a spreadsheet; a column in a table; a dimension of a display device or a location on a map.

The invention is not an abstract algorithm or idea, but rather a practical application involving a system and method of storing data or files in enhanced paths, and of manipulating information about the stored data or files that provides the user with information about the stored files in a way that shortcuts the restrictions normally present in a hierarchical file system. The invention ultimately involves input by a user of data and meta-data information and procedures for manipulating the data and meta-data information in a way that is meaningful to the user, and displaying the results of the calculations. As such, the invention requires at least an input device, a data storage device and a computer-readable medium, a data processing device for performing the calculations, and an output device that either controls a display or that provides output data that can be communicated over a network or other communications medium to a display device. The invention may be applied both to an individual computing system and also to client-server architectures, in a multi-user or single-user setting.

### 3.3 Advantageous Effects of the Invention

The advantageous effects of the invention comprise of the abilities to
increase the flexibility and
increase the correctness and
decrease the required memory consumption of data and
decrease the required memory consumption of the meta-data and
increase the performance of calculations in data system.

### 4 BRIEF DESCRIPTION OF DRAWINGS

All of the figures in this document follow an open world assumption, that is: it is not because something is not depicted in a figure, that it can be concluded that it is not there. This is because having to depict everything that is there in figures would make them impractically large and bloated and the figures would lose their ability to aid in the understanding of the invention. One example of this, is that back-link paths, that are automatically generated by the system, may be left out when they are not relevant to the aspect that we are currently disclosing. This however does not imply that they are not there, but rather that they would increase the complexity of the picture to much in comparison to the explainational power that they would provide. In addition to this, some figures may have elements added to them that are not strictly needed in the invention, but aid in explaining the aspect at hand. So, it is not because something is depicted in a figure, that it can be concluded that it is required to enable the invention.

In general we can simply say that the role of the pictures in this document is to explain the invention, not to determine its scope, this is the role of the claims. More concretely, the presence or lacking of elements in the figures is an indication that said element would have aided or obstructed in explaining a certain aspect of the invention, rather than it is saying something about the presence of said element in the invention itself.

FIG. 1, which is intended to be non-limiting, illustrates a valid arrangement of entities in paths according to the principles of the invention.

FIG. 2, which is intended to be non-limiting, illustrates various relationships between identities according to one at least one embodiment of the invention.

FIG. 3, which is intended to be non-limiting, illustrates a model according to one at least one embodiment of the invention.

FIG. 4, which is intended to be non-limiting, illustrates how fields have values for their subjects according to one at least one embodiment of the invention.

FIG. 5, which is intended to be non-limiting, illustrates how the user can interact with applications through a user interface that is similar to the user interface of conventional file systems according to one at least one embodiment of the invention.

FIG. 6, which is intended to be non-limiting, illustrate how sub-paths can be repeated for each member of path, thereby showing the value of said path per member, according to one at least one embodiment of the invention.

FIG. 7, which is intended to be non-limiting, illustrates how applications can be mounted under conventional file systems according to one at least one embodiment of the invention.

FIG. 8, which is intended to be non-limiting, illustrates how multiple computation nodes may together form the data system according to one at least one embodiment of the invention.

FIG. 9, which is intended to be non-limiting, illustrates a flow of messages according to one at least one embodiment of the invention.

FIG. 10, which is intended to be non-limiting, illustrates how a set of attributes can be projected onto a spreadsheet according to one at least one embodiment of the invention.

FIG. 11, which is intended to be non-limiting, illustrates how entities can be visually projected onto a 2 or higher dimensional plane according to one at least one embodiment of the invention.

FIG. 12, which is intended to be non-limiting, illustrates how the members of a path can be projected onto a table according to one at least one embodiment of the invention.

FIG. 13, which is intended to be non-limiting, illustrates how the invention may have calculated attributes according to one at least one embodiment of the invention.

FIG. 14, which is intended to be non-limiting, illustrates one possible BNF that may be used as the syntactic basis of formulas according to one at least one embodiment of the invention.

FIG. 15, which is intended to be non-limiting, illustrates a possible AST of a formula according to one at least one embodiment of the invention.

FIG. 16, which are intended to be non-limiting, illustrates how the user interface of the data system may suggest formulas to the user based on the fields that he or she has selected according to one at least one embodiment of the invention.

FIG. 17, which is intended to be non-limiting, illustrates a model that uses inheritance according to one at least one embodiment of the invention.

FIG. 18, which is intended to be non-limiting, illustrates a model that has atomic, subset and link paths according to one at least one embodiment of the invention.

FIG. 19, which is intended to be non-limiting, illustrates a method used to display identities of entities, set in a proper context, can be used according to one at least one embodiment of the invention.

FIG. 20, which is intended to be non-limiting, illustrates how the values of derived path implementations are calculated according to one at least one embodiment of the invention.

FIG. 21, which is intended to be non-limiting, illustrates how the filter of several implementations may be the union of the filter of other implementations according to one at least one embodiment of the invention.

FIG. 22, which is intended to be non-limiting, illustrates example data in some filters according to one at least one embodiment of the invention.

FIG. 23, which is intended to be non-limiting, illustrates how the members of a path are influenced by the current fields of its subjects according to one at least one embodiment of the invention.

FIG. 24, which is intended to be non-limiting, illustrates how the value of attribute implementations may be calculated according to one at least one embodiment of the invention.

FIG. 25, which is intended to be non-limiting, illustrates a structure to persist the none-calculated values according to one at least one embodiment of the invention.

FIG. 26, which is intended to be non-limiting, illustrates a model that uses inter-life-time polymorphism according to one at least one embodiment of the invention.

FIG. 27, which is intended to be non-limiting, illustrates a back-link path according to one at least one embodiment of the invention.

FIG. 28, which is intended to be non-limiting, illustrates how grouping may be realized according to one at least one embodiment of the invention.

FIG. 29, which is intended to be non-limiting, illustrates how grouping of references may be realized according to one at least one embodiment of the invention.

FIG. 30, which is intended to be non-limiting, illustrates a model that uses a multi-structured type according to one at least one embodiment of the invention.

FIG. 31, which is intended to be non-limiting, illustrates the recursive nature of type inference according to one at least one embodiment of the invention.

FIG. 32, which is intended to be non-limiting, illustrates one structure that could be used to realise such a recursive type inference system according to one at least one embodiment of the invention.

FIGS. 33-37, which are intended to be non-limiting, illustrate how the type inference enables various modelling features.

FIG. 38, which is intended to be non-limiting, illustrates how actions are executed according to one at least one embodiment of the invention.

FIG. 39, which is intended to be non-limiting, illustrates how extra kinds of paths may be added to integrate with external systems according to one at least one embodiment of the invention.

FIG. 40, which is intended to be non-limiting, illustrates dependencies may be visualized according to one at least one embodiment of the invention.

FIG. 41, which is intended to be non-limiting, illustrates how an attribute can be accumulated according to one at least one embodiment of the invention.

FIGS. 42-44, which are intended to be non-limiting, illustrate some possible interfaces to an example application according to one at least one embodiment of the invention.

FIG. 45, which is intended to be non-limiting, illustrates a model that can be used to keep track of patent applications by patent agents according to one at least one embodiment of the invention.

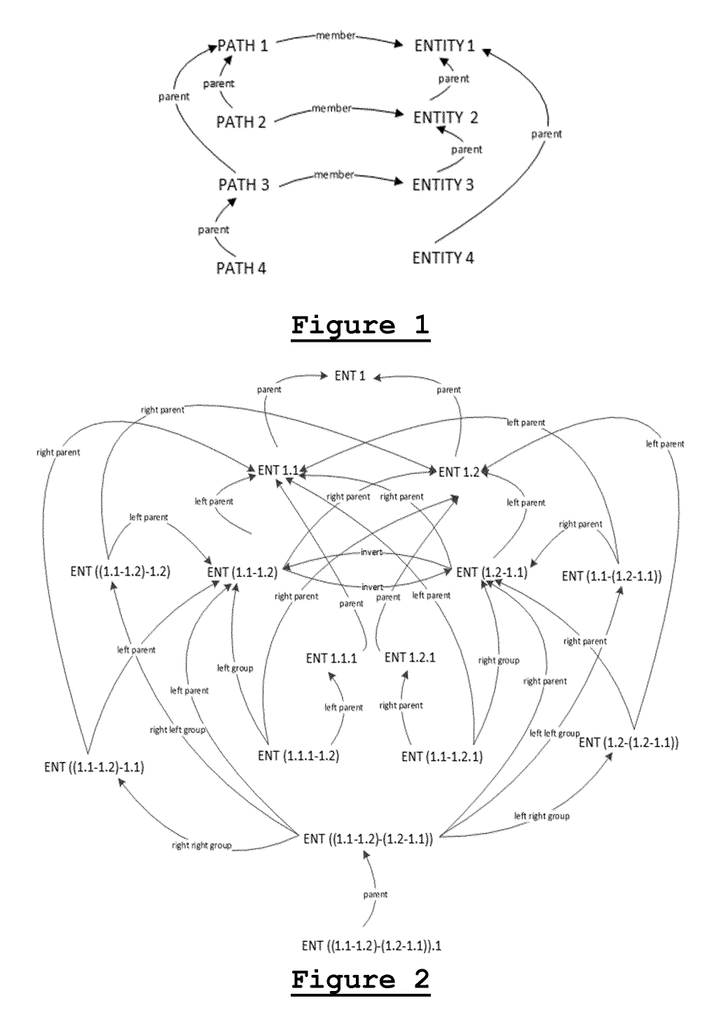

### 5 DESCRIPTION OF EMBODIMENTS

### 5.1.1 Identities (FIG. 2)

According to one preferred embodiment every entity has one unique identity and the identities of the parents are encoded in this identity. There are three kinds of identities, root identities, atomic identities and combined identities for respectfully representing entities who have zero, one or two parents. Entities that have zero parents are represented by “root identities,” whole numbers that are unique within the system, e.g. “1”, “2”, “3”, etc. Entities that have one parent are represented by “atomic identities,” the identity of the parent entity and a whole number that is unique within that parent separated by a dot, e.g. “1.1”, “1.2”, “2.1”, etc. Entities that have two parents are represented by “combined identities,” the identity of left parent entity and the identity of the right parent entity separated by a dash and surrounded by parenthesis, e.g. “(1.1-1.2)”. Combined identities may also be called “links”.

“1.1” and “(1.1-1.2)” are called “child identities” of their respective parents “1” and “1.1”, and vice versa “1.1” and “1.2” are called “parent identities” of “(1.1-1.2)”.

The “distance” between an entity A and one of its descendants, is the number of times that, starting from one given descendent, the parent must be recursively determined in order to arrive at said entity A. For example, the distance between
“1” and “1.1” is 1
“1” and “1.4.8.1” is 3
“3.4” and (“1.1”-“3.4”).3.1 is 3

According to a further alternative embodiment of the invention there is provided
a method for visually displaying the identity of a first entity in a data system comprising a display device; and
a non-transitory computer readable medium embodying information indicative of computer executable instructions that when executed by a calculation device performs said method,
   said method comprising
displaying a sequence of characters representing the identity of said first entity on said display device, said sequence of characters comprising the identities of the parent entities of said first entity,
   wherein possibly
said first entity is a member of a path in said data system; and
in said data system there is a second entity that is a parent entity of said first entity; and
said second entity is a member of the parent path of said path in said data system; and
said path has an attribute
   or alternatively wherein possibly
said first entity can be a member of a path in said data system; and
in said data system there can be a second entity that is a parent entity of said first entity; and
said second entity can be a member of the parent path of said path in said data system; and
said path can have an attribute

Variations of the above embodiment include embodiments wherein further possibly
said first entity has at least two parent entities; or
said first entity is a member of two paths in said data system; or
one of the paths in said two paths inherits from the other path in said two paths; or
said attribute is associated with a formula that the user can alter, or alternatively wherein possibly
said first entity can have at least two parent entities; or
said first entity can be a member of two paths in said data system; or
one of the paths in said two paths can inherit from the other path in said two paths; or
said attribute can be associated with a formula that the user can alter.

In order words the identities of child entities are formed out of the identities of parent entities.

Those skilled in the art will appreciate any sequence of characters that allow the system to uniquely identify an entity forms an identity and that identities may thus also be formed from more human readable strings. For instance, “(FruitJuiceInc-AnnMcRonnalds)” could form the identity of an employment.

Alternative embodiments of said embodiment print the identity of an entity on paper. Those skilled in the art will appreciate that this way of visualizing entities is more compact the alternative visualization, such as graphs, and therefore consumes less ink when printed on paper, is and faster to render on a display device since less pixels need to be altered. Besides this, this more compact way of representing entities means that users have to input fewer characters, when they want to retrieve an entity by its identity.

In at least one preferred embodiment, starting from one entity's identity we can calculate the identities of related entities; these calculations are embodied in “references”. The “primary related entities” that can be calculated are the parent for atomic identities and the left and right parent for combined identities. Built on top of these there are the “secondary related entities” that can be calculated for combined identities;
The “left group” can be calculated for a combined identity whose left parent is atomic by forming a new combined identity from the parent of the left parent of that identity with the right parent of that identity.
The “left left group” can be calculated for a combined identity whose left parent is combined by forming a new combined identity from the left parent of the left parent of that identity with the right parent of that identity.
The “left right group” can be calculated for a combined identity whose left parent is combined by forming a new combined identity from the right parent of the left parent of that identity with the right parent of that identity.
The “right group” can be calculated for a combined identity whose right parent is atomic by forming a new combined identity from the left parent of that identity with the parent of the right parent of that identity.
The “right right group” can be calculated for a combined identity whose right parent is combined by forming a new combined identity from the left parent of that identity with the right parent of the right parent of that identity.
The “right left group” can be calculated for a combined identity whose right parent is combined by forming a new combined identity from the left parent of that identity with the left parent of the right parent of that identity.
The “invert” can be calculated for a combined identity by forming a new combined identity from the right parent of that identity with the left parent of that identity.

In formula notation, this can be summarized by

LG(identity)=CI(P(LP(identity)),RP(identity))

LLG(identity)=CI(LP(LP(identity)),RP(identity))

LRG(identity)=CI(RP(LP(identity)),RP(identity))

RG(identity)=CI(LP(identity),P(RP(identity)))

RRG(identity)=CI(LP(identity),RP(RP(identity)))

RLG(identity)=CI(LP(identity),LP(RP(identity)))

, wherein P is parent, LP is left parent, RP is right parent, CI is combined identity, LG is left group, LLG is left left group, LRG is left right group, RG is right group, RRG is right right group and RLG is right left group. The preferred embodiment also has a reference called “root” that returns the root entity of the data-set to which the entity belongs.

Embodiments may choose to flag delete entities as deleted, called a “soft delete”, or truly physically delete them from the underlying storage device, a “hard delete”. Entities that are soft deleted can be “resurrected”. In at least one preferred embodiment, when an entity is flagged as deleted, so are all of its descendants. Combined with paths this enables “by-value collections”. Identities allow us to easily see these existential connections. In the hole of this document, the term “delete” shall mean hard delete or soft delete, when the hardness is not explicitly specified.

In at least one preferred embodiment, when two combined identities have the same left and right parent, they form the same identity and refer to the same entity. This is similar to how two notations of “5” denote the same underlying entity, the value 5, in a similar fashion, “(1.1-2.3)” is “(1.1-2.3)”, there can never be two “(1.1-2.3)”s. This enables a feature called “link instance unification”.

FIG. 2, which is intended to be non-limiting, illustrates these relationships between identities according to one at least one embodiment.

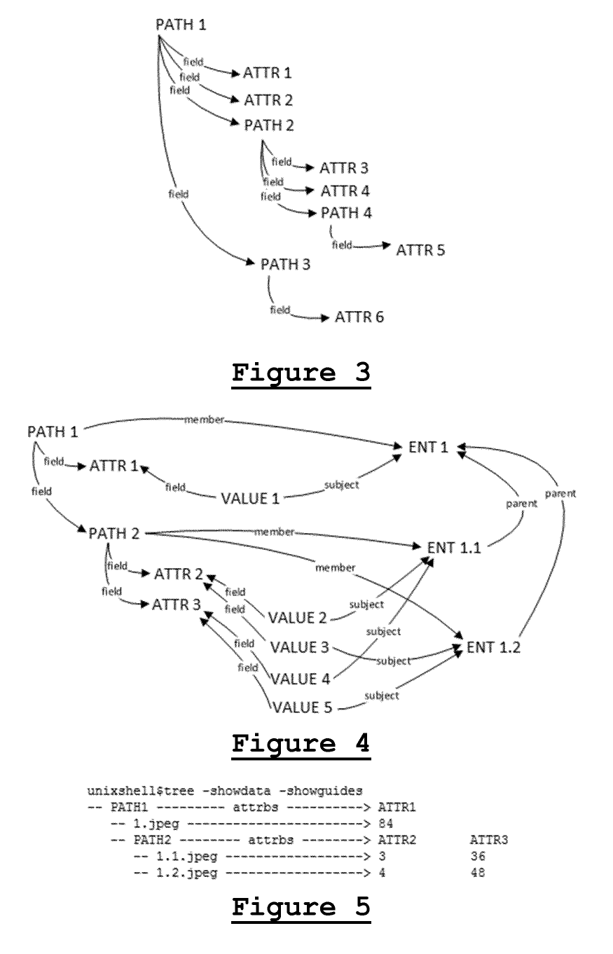

### 5.1.2 Fields (FIG. 3)

According to a further preferred embodiment paths have attributes and sub-paths, collectively referred to as fields. Such a set of fields is called a “model” or “meta-data” and together with “data”, which is the set of entities and their values on which a system operates, it forms an “application”. All fields in a model can be written down in a format called “path notation”. The fields of an entire application written down in path notation is called an “application map”.

FIG. 3, which is intended to be non-limiting, illustrates such a model according to one at least one embodiment. In path notation it would be represented as:

/PATH1/
/PATH1/ATTR1
/PATH1/ATTR2
/PATH1/PATH2
/PATH1/PATH2/ATTR3
/PATH1/PATH2/ATTR4
/PATH1/PATH2/PATH4
/PATH1/PATH2/PATH4/ATTR5
/PATH1/PATH3
/PATH1/PATH3/ATTR6

Note that
“/PATH1/PATH3” identifies a path while
“/PATH1/PATH3/ATTR6” identifies an attribute,
   although it is also textually written as a path.

Alternatively, any path that is mentioned may simply be presumed to exist, allowing us the write down the same model as

```
    /PATH1/ATTR1
/PATH1/ATTR2
    /PATH1/PATH2/ATTR3
    /PATH1/PATH2/ATTR4
    /PATH1/PATH2/PATH4/ATTR5
    /PATH1/PATH3/ATTR6
```

We say that a path has fields “on it” or alternatively “under it”, as in “The fields under PATH 1 are ATTR 1, ATTR 2, PATH2 and PATH 3”. When a path had an attribute under it, we may also say that said attribute is an attribute of said path.

### 5.1.3 Values (FIGS. 4-7)

According to a further preferred embodiment, fields have values for their subjects and applications can be represented by user interfaces similar to those of conventional file systems.

FIG. 4, which is intended to be non-limiting, illustrates according to one at least one embodiment how fields have values for their subjects. By using the path notation and extending it with a notation for associative arrays, similar to json, the values of an application can be easily written down:

/PATH1/ATTR1.values = {1:value1}
/PATH1/PATH2.values = {1:{1.1, 1.2}}
/PATH1/PATH2/ATTR2.values = {1.1:value2,1.2:value3}
/PATH1/PATH2/ATTR3.values = {1.1:value4,1.2:value5}

Is this example, each entity in the value of PATH2 for entity “1”, a collection comprising entities “1.1” and “1.2”, has the fields ATTR2 and ATTR3. This is an example of a feature called “typed collections”.

When talking about the value of a field for an entity, we may alternatively say
the value of a said field of a said entity, or
the value for a said field of a said entity, or
the value of a said field for a said entity, or
the value for a said field for a said entity, or
said field's value for said entity, or
said field's value of said entity, or
said entity's value for said field, or
said entity's value of said field.

According to a further alternative embodiment of the invention there is provided
a method for retrieving the value of a first path of an entity that is a member of the parent path of first child path in the system comprising a calculation device, a storage device and a display device or
a non-transitory computer readable medium embodying information indicative of computer executable instructions that when executed by a calculation device in data system perform said method
   , said method comprising
determining all descendent entities of said entity that are members of said first path using said calculation device and
   possibly followed by sending the determined entities to a client when said client comprises said display device and participates in a client-server architecture or a peer-to-peer network that forms said data system; or alternatively
   possibly followed by displaying the determined entities on said display device when said display device is connected to a computing node that comprising said calculation device and said storage device,
      wherein possibly
said first path has a numerical attribute; or
said first path inherits from another path; or
the determined entities comprise at least two entities; or
said entities are files or associated with files and said paths are folders or tags; or
said entities are programming object and said paths are classes,
   in a system that further possibly has support for super positioned memberships, link typing, multi-memberships, spreadsheet mapping and all other technical features disclosed in this document.

Those who are skilled in the art will appreciate that precisely this method of determining the value of a path of an entity, allows for the higher structural features of the inventions, such as multi-memberships, volatile fields and type by-value collection who, as explained in the section 4.1.1, called “higher semantics”, reduce memory consumption, increase flexibility and makes the system less prone to bugs.

FIG. 5, which is intended to be non-limiting, illustrates according to one at least one embodiment how the user can interact with applications through a user interface that is similar to the user interface of conventional file systems. It shows the output of a modified tree command, a command used to print a directory structure in a Unix shell, with the following data:

/PATH1/ATTR1.values = {1:84}
/PATH1/PATH2.values = {1:{1.1,1.2}}
/PATH1/PATH2/ATTR2.values = {1.1:3,1.2:4}
/PATH1/PATH2/ATTR3.values = {1.1:36,1.2:48}

Those skilled in the art will appreciate that although in the figure each entity is associated with a “.jpeg” file, any kind of file may be associated with an entity. Further, paths may be restricted to have a maximum of one element in their value for each of their subjects. These paths are called “single” while paths that don't have this constraint are called “multi” and this is similar to accessing a pointer or a collection of pointers in conventional programming languages. Embodiments may realize this behaviour by removing the previous element when a new element is added, or forcing the user to remove said entity himself prior to adding a new one.

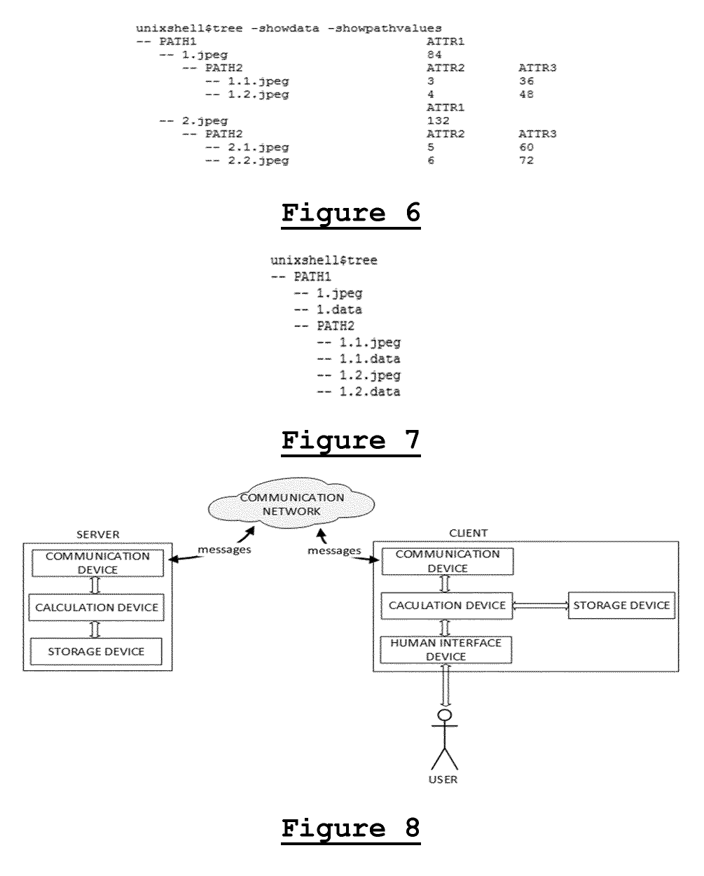

FIG. 6, which is intended to be non-limiting, illustrates according to one at least one embodiment how sub-paths can be repeated by showing the same application with some extra data and repeating the path2 sub-path for each member of path1. It shows two data-sets with root identities “1” and “2”.

FIG. 7, which is intended to be non-limiting, illustrates how according to one at least one embodiment applications can be mounted under conventional file systems by storing the values of fields in “.data” files, preferably encoded as text files. Adapting the values stored in the “.data” files adapts the values in the system and vice versa. Embodiments may choose to use standards like WebDAV or FTP to accomplish this. This feature is called “file system exposability”.

According to one preferred embodiment, each path may have one attribute that contains the user friendly name of the entity. The name of a person or the invoice number of an invoice are good examples of such user friendly names. In preferred embodiments, the user can configure the system to display the user friendly name or the identity or both, when listing entities.

### 5.1.4 Hardware Client-Server Implementation (FIGS. 8-9)

One possible arrangement of hardware components for implementing the above described system and example user interface according to one preferred embodiment is made up of nodes connected though a communication network who are comprised of a communication device, a calculation device, a storage device and optionally a output device optimized for human receivers. Together these nodes form a client-server or peer to peer architecture wherein all nodes may operate as “servers” while only nodes that have an output device optimized for human receivers may operate as “clients”. Those skilled in the art will appreciate that the different server nodes collectively operate as a cluster that can be viewed as a single system wherein load balancing, backup, high availability, eventual consistency, data partitioning and replication techniques may be applied as is common with distributed database—and file systems. FIG. 8, which is intended to be non-limiting, illustrates one such system according to one at least one embodiment comprising one client and one server.

According to a further embodiment clients send “update command messages,” commands that updates data or meta-data, and “data request command messages,” commands that request data or meta-data, to the cluster who responds with “command response messages”. In some embodiments the cluster may send “notification messages” to clients to inform them that an event of interest has occurred, such as a change in the data or meta-data of an application. In response, the client may use this information to update its output device optimized for human receivers or to update its cached data or any of a variety of other scenarios, such as to simply inform the user that some data has changed. Further, some embodiments may choose to filter those notifications on a per client basis, possibly based on a system wherein a client may register himself as an observer of certain subsets of the data or meta-data of an application. In this scenario clients may request a subset of the data or meta-data and may simultaneously register as an observer for that subset of the data or meta-data. FIG. 9, which is intended to be non-limiting, illustrates such a flow of messages according to one at least one embodiment in one such system comprising two clients and one server.

All nodes and messages are preferably optimized for operating in a network environment and thus try to minimize bandwidth and latency by utilizing caching and data transfer techniques such as using a web cache to cache data locally, pre-fetching the data, compressing the data and sending over diffs followed by patching the locally stored data. Those skilled in the art will appreciate that different kinds of data and messages, e.g. meta-data vs. BLOB data, may be transferred by using different protocols over different communication media, e.g. XML, JSON, ftp, named pipes, torrents, SMB, TCP/IP.

Those skilled in the art will further appreciate that different embodiments may provide different granularities by which data can be requested or observed. For example, a client may request the value of one or multiple fields of one or multiple entities by packaging multiple requests into one or by sending a generalized query, similar to SQL queries and triggers in relational databases.

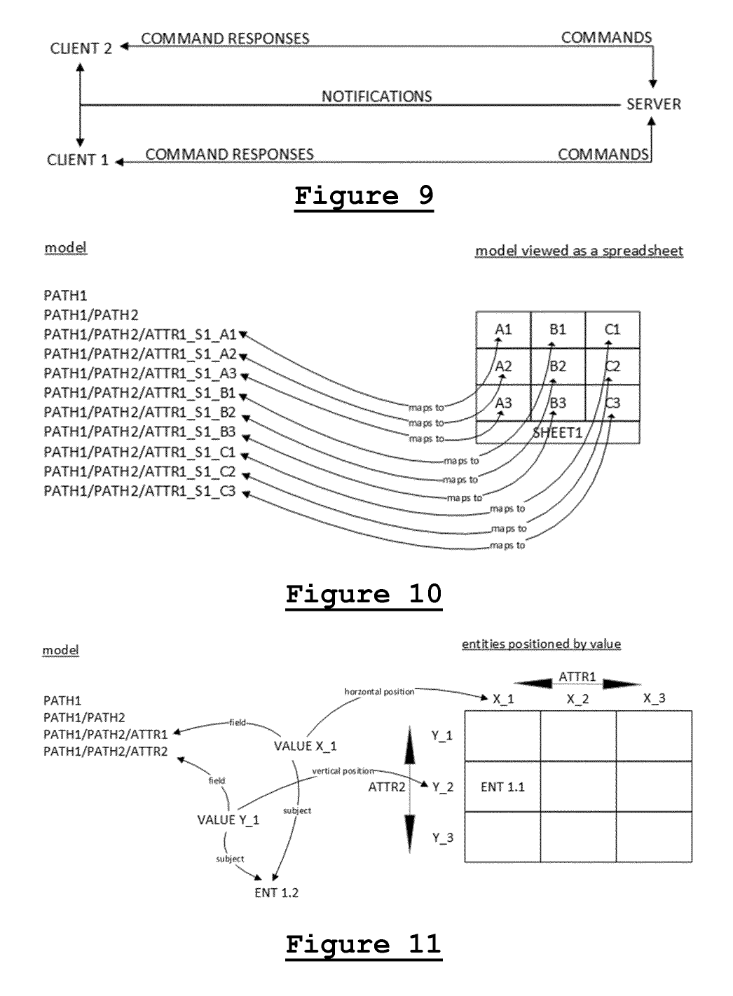

### 5.1.5 Grids (FIG. 10-12)

According to one preferred embodiment the data of an application can be projected onto a grid, or vice versa, according to various ways.

FIG. 10, which is intended to be non-limiting, illustrates how according to one at least one embodiment a set of attributes can be projected onto a spreadsheet by associating each attributes with a sheet, column and row number. Such an attribute is called “mapped” and this feature enables “spreadsheet mapping”. Updating such an attribute updates the associated cell and vice versa. Every member of PATH 2 has an associated spreadsheet with the same formulas, the formulas of the associated attributes, and different data, the overridden values of the associate formulas. Allowing formulas to reference attribute by a name query, e.g. ‘Sum(A1:A3)’, and adding the relative cell copy behaviour common to spreadsheets completes the spreadsheet mapping. Since spreadsheets usually have a very big plane, it may be impractical to create one attribute per cell. A simple way around this is simply to delay the creation of the associated attribute to the point when the user first inputs a value or formula into a cell. Some embodiments may choose to hide these generated “spreadsheet” attributes. Mapped attribute may reference none-mapped attributes in their formulas and vice versa.

According to a further alternative embodiment of the invention there is provided a method for displaying a value of an attribute as a value of a cell in a spreadsheet.

FIG. 11, which is intended to be non-limiting, illustrates how according to one at least one embodiment entities can be visually projected onto a 2 or higher dimensional plane based on the values of their attributes, a feature called “2D mapping”. When the user alters the position of an entity the values of the associated attributes preferably are altered accordingly and vice versa.

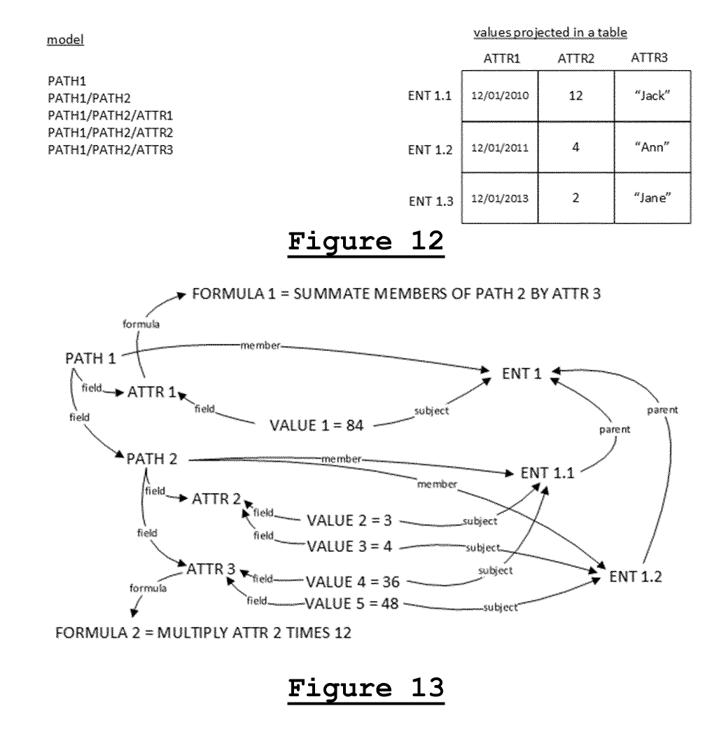

FIG. 12, which is intended to be non-limiting, illustrates how according to one at least one embodiment the members of a path, e.g. path1, can be projected onto a table by creating a column for each attribute of that path and inserting row for each member of that path. A feature called “table mapping”. Of course the inverse direction can also easily be done. Those skilled in the art will appreciate that this allows for easy import, export and synchronization of data through relational database tables, CSV and spreadsheet files with external data systems. The preferred embodiment would implement a subset of SQL and expose this through wherein each path is represented as a relational database table.

According to at least one preferred embodiment, attributes may also have a global positioning value comprising of latitude and longitude which can be used to position the subjects of those values to be positions on a map, e.g. a world map or a street map. Updating the position of the entity on the map updates the underlying global positioning value.

### 5.1.6 Formulas (FIG. 13-16)

According to one preferred embodiment the values of fields may be calculated by a runtime engine, by letting the user associate formulas with fields, enabling a feature called “declarative calculated values”, or simply “calculated values”. That part of the data system that operates on data in general is called the “runtime engine”. The term “formula” is to be interpreted as binary information that embodies a calculational relationship that is configured by a user between one field and a set of other fields. Two popular ways of specifying such a calculation relationships is by entering a formula in a textual form, e.g. “SUM(EMPLOYEES, E->E.SALARY)”, or by inputting it through a graphical user interface. In preferred embodiments, the graphical user interface can generate these textual formulas, so that the user does not need to know the correct syntax of these formulas. Since formulas affect the current paths of an entity who in turn affect the current fields of an entity, formulas can make the presence of a field on an entity dynamic, enabling a feature called volatile fields.

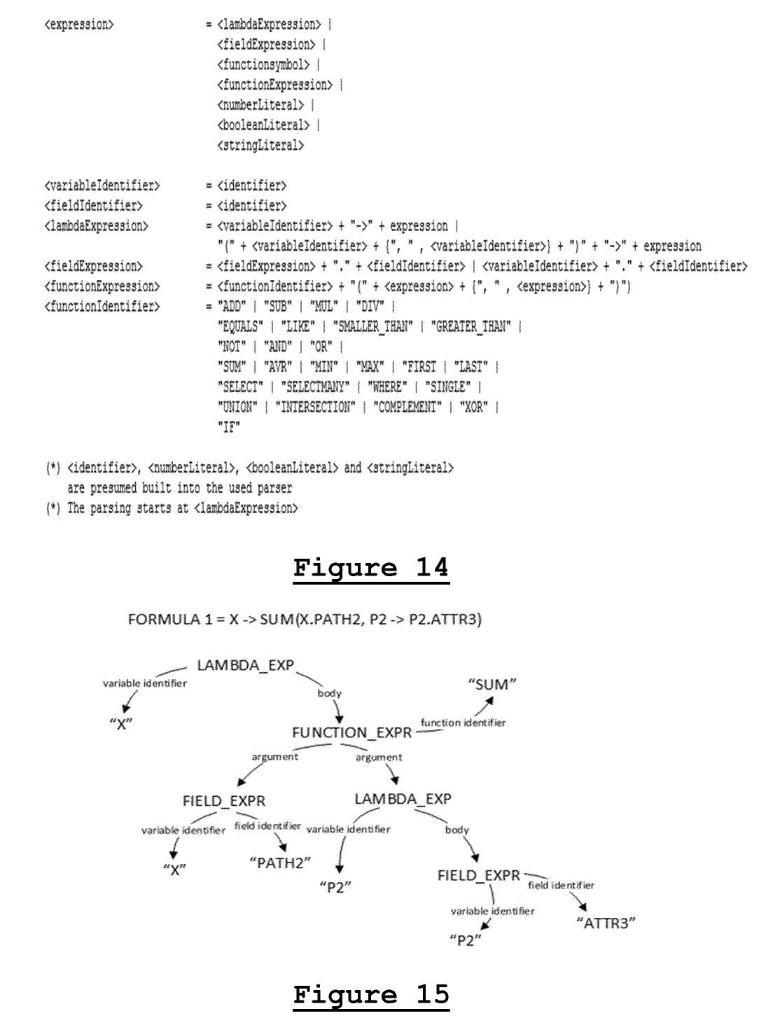

FIG. 13, which is intended to be non-limiting, illustrates how according to one at least one embodiment the invention may have calculated attributes. According to one preferred embodiment the syntax of the textual formulas may be structured according to the BNF shown in FIG. 14, which is intended to be non-limiting, wherein the functions “SELECT”, “SELECTMANY”, “WHERE”, “SINGLE”, “UNION, “INTERSECTION”, “COMPLEMENT” and “XOR” have the same behaviour as their C# LINQ counterparts. An example according to one at least one embodiment of the resulting AST for the textual formula “X->SUM(X.PATH2, P2->P2.ATTR3)”, that is summating the members of path by attribute 3, is shown in FIG. 15, which is intended to be non-limiting. In this example we may say that the field expression “P2.ATTR3” referring to field ATTR3, is “embedded” in the formula “X->SUM(X.PATH2, P2->P2.ATTR3)” that contains a SUM function.

Standard parser generation frameworks, such as YACC and LEX, may be used to generate to parser for this language. Those skilled in the art will appreciate that the example BNF has been deliberately kept minimalistic and that all functions that are commonly found back in spreadsheets and SQL as well as reference fields can be easily added and are present in preferred embodiments. Like in most conventional languages, the deeper fields of expressions that return a structured type, such as the return type of a field expression of a single path field, can be accessed using a dot notation, e.g. “X->X.SOME_SINGLE_PATH.SOME_DEEPER_FIELD”.

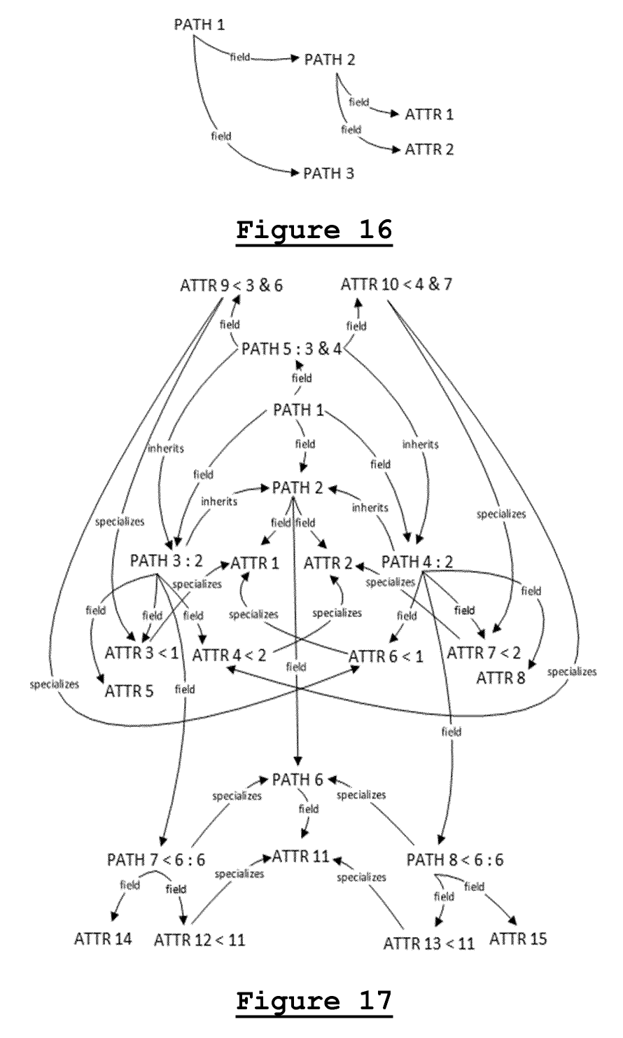

FIG. 16, which are intended to be non-limiting, illustrates how according to one preferred embodiment formulas are suggested to the user based on the fields that he or she has selected, a feature called “formula suggesting”.

According to a further alternative embodiment of the invention there is provided
a method for suggesting formulas to a user in a data system; or
a non-transitory computer readable medium embodying information indicative of instructions that when executed by a calculation device in a data system perform said method, said data system comprising
a first path, called PATH 1; and
a second path, called PATH 2, under said PATH 1; and
a first attribute, called ATTR 1, under said PATH 2; and
a second attribute, called ATTR 2, under said PATH 2; and
a third path, called PATH 3, under said PATH 1,
   said method comprising
when only PATH 2 is selected
   letting the user choose on action from a subset of the following actions
      creating a new path under PATH 1 with a formula that filters PATH 2 based on ATTR 1; or
      creating a new path under PATH 1 with a formula that filters PATH 2 based on ATTR 2; or
      creating an attribute under PATH 1 that aggregates the members of PATH 2 by ATTR 1 or ATTR 2; or
      creating an new path under PATH 1 that groups the members of PATH 2 by ATTR 1; or
      creating an new path under PATH 1 that groups the members of PATH 2 by ATTR 2,
         Examples of such generated formulas may be
         “WHERE(PATH2, P2->P2.ATTR1==TRUE)”
         “WHERE(PATH2, P2->P2.ATTR1<10)” or
         “SUM(PATH2, P2->P2.ATTR2)” or
         “SELECT(PATH2, P2->P2.ATTR1)”.
when PATH2 and PATH 3 are selected
   letting the user choose on action from a subset of the following actions
      creating a new path under PATH 1 with a formula that unions or intersects the members of PATH 2 and PATH 3, e.g. “UNION(PATH2, PATH3)” or “INTERSECTION(PATH2, PATH3)”.
when ATTR 1 and ATTR 2 are selected
   letting the user choose on action from a subset of the following actions
      the system may suggest to create a new attribute under PATH 2 with a formula that uses the values of ATTR 1 and ATTR 2, e.g. “ATTR1+ATTR2”,
         wherein optionally
said data system further comprises a first entity that is a member of said first path; or
said data system further comprises a second entity that is a member of said second path and a descendent entity of said first entity; or
under said PATH 2 is a reference field whose return type is said PATH 1.

The advantages of suggesting formulas the user this way is an extreme improvement of user friendliness, a reduction of bugs, and because new functionally to be added to systems much faster because of this, an increase in flexibility. The reason why these formulas can be suggested is a direct consequence of the special data structuring features of the invention.

The textual formulas work similar to C# lambdas invoked on the members of the path to which the field of the formula belongs; to calculate the value of an attribute or a sub-path for a certain subject, e.g. a member of path1, the subject is passed in through the outer lambda variable, e.g. “X” and its fields are accessed, e.g. “.PATH2”, to calculate the return value of the lambda, e.g. “84”. Some embodiments may make the outer lambda expression implicit, e.g. “SUM(PATH2, P2->P2.ATTR3)”.

Those skilled in the art will appreciate that any syntax that can be automatically translated into this example syntax by means of a computer is a merely a different depiction of calculation relationship and that by extension this discloser is enabling and claiming that syntax to the same extend as it is enabling and claiming the provided example syntax.

When a field has an associated formula that references another field, we say that said the former field is “dependent on” the latter field. A field is always dependent on its parent field. In the preferred embodiment, cyclic dependencies are preferably not allowed. Hence, the fields in the system form a acyclic graph, called the “field dependency graph”.

Since the syntax of the textual formulas is a subset of C#, textual formula can be easily compiled at runtime without the need for any parser or interpreter. By sorting the fields topologically based on their dependencies, followed by calculating the value of each field by invoking the compiled lambda for each of its subjects in response to the user altering the value of a field, the values of all fields can easily be calculated, as conventional in reactive programming.

Some embodiments may choose to recalculate the values of a field when one of the inputs of its associated formula has changed, similar to spreadsheets. This can be done simply by adding the formula as an observer to each field, following the observer pattern, on which it depends. When a value of such a field on which it depends then changes, it send a message to the dependent field which then recalculates all of its values or a subset thereof in response to that message. When the formula aggregates over a dynamic amount of entities this enables a feature called “self-updating aggregates”.

According to a further alternative embodiment of the invention there is provided
a method for recalculating a value of a first field in response to one of the values of one of the fields on which said field is dependent changing in a data system comprising a field dependency graph; or
a non-transitory computer readable medium embodying information indicative of instructions that when executed by a calculation device in a data system perform said method,
   said method comprising
recalculating a value for each field that
   is an ancestors of said first field in said field dependency graph
   is a descendant of said second field in said field dependency graph in a recursive manner.

In one preferred embodiment, a formula may also simply return all instances of a path, e.g. “X->MEMBERS_OF(‘/PATH/PATH/PATH’)”, and thus require no calculation, but rather only retrieval.

Those skilled in the art will appreciate that a class in an object oriented systems is in essence a set of attributes under a common name. A path is thus a specialized kind of class that has ‘parent classes’.

According to a further alternative embodiment of the invention there is provided
a method for determining the classes of which an object is an instance in an object oriented data system; or
a non-transitory computer readable medium embodying information indicative of instructions that when executed by a calculation device in a data system perform said method,
   wherein
the classes of which said object is an instance can change over the life time of said object; and
one class has an associate formula that determines its extent and
when said object becomes an instance of said class, all attributes of said class are present on said object,
   said method comprising
using said formula to determine if said object is an instance of said class,
   wherein possibly
said data system comprises computer executable instructions that embody support for inheritance; or
said data system comprises computer executable instructions that embody support for volatile fields; or
said data system comprises computer executable instructions that embody support for spreadsheet mapping; or
the attributes in said system are renamable at runtime.

Those skilled in the art will appreciate that in the preferred embodiment, fields may have associated formulas that extract information from the files that are associated with their subjects by:
locating the associated file
opening said file
reading bytes from said file

For example, in the model

/DATASETS/INVOICES/VAT.formula=“SEARCH_NUMBER_AFTER(FILE, ‘VAT:’)”
the formula “SEARCH_NUMBER_AFTER(FILE, ‘VAT:’)” searches for a number after the phrase ‘VAT:’ in the file associated with each invoice. Many variations of the formula “SEARCH_NUMBER_AFTER” can easily be added to any embodiment that has calculated fields.

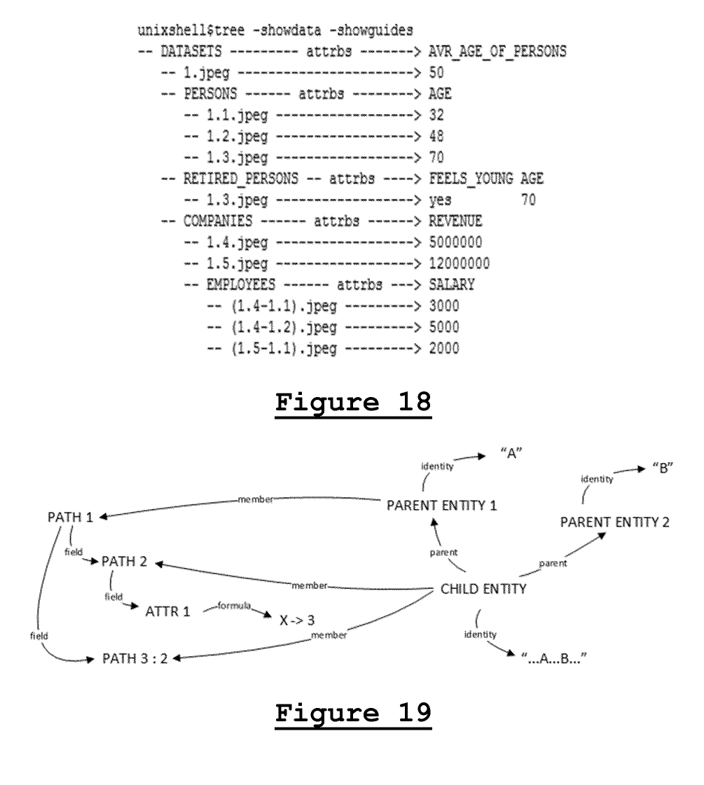

### 5.1.7 Inheritance (FIG. 17)

According to one preferred embodiment a path can inherit the fields from other paths. More concretely, a path inheriting from another path causes that path to have a more “specialized” “implementation” of each field, that is not a reference, of the first path. The paths from which a path inherits are called its “base” paths. The inherence relationships form acyclic directed graphs each with one or more roots while the specializations form multiple acyclic directed graphs each with exactly one root. In these last graphs, the root of each such graph is called a “primal field” while its descendants are called “secondary fields”. Parent and child implementations in these graphs are called “upper” and “lower” implementations, in other words an implementation's lower implementations specialize that implementation. We collectively refer to the primal field and its secondary fields as the “implementations” of that primal field. The implementations of a primal field are polymorphic, meaning that they can be referenced by a common identifier, called the “field identifier”, but have a different implementation. At runtime the system will select the correct implementation to determine the “polymorphic value” of the associated primal field for a subject, a concept known as dynamic dispatch. The terms “polymorphic” and “dynamic dispatch” refer to terms in the art of the field of object oriented programming.

When entities are members of multiple paths at the same time, a primal field may have multiple implementations in the current fields of an entity. According to that same preferred embodiment, the polymorphic value of that primal field is determined by the most “polymorphically dominant” implementation. This “polymorphically dominant” implementation is determined by the “polymorphic dominance,” an ordering of the implementations of a primal field that is configurable by the user. The value of an entity for all implementations of a primal field is the same, being the polymorphic value of that primal field of that entity. For implementations that are paths, only when an entity is an element of one of the polymorphic values of an implementation is it a member of that implementation.

In at least one preferred embodiment, paths automatically inherit from the paths that they specialize, a concept called “deep inheritance” causing a polymorphic behaviour called “deep polymorphism”.

In path notation inheritance of paths may be indicated by appending a colon to the path identifier followed by the identifiers of the path of which it inherits separated by a ampersand, e.g. “PATH 5: 3 & 4” indicates that path 5 inherits from path 3 and path 4. The specialization of a field may be indicated by appending a smaller than character to the field identifier followed by the identifiers of the field of which it inherits separated by an ampersand, e.g. “ATTR 9<3 & 6” indicates that attribute 9 specializes attributes 3 and 6.

FIG. 17, which is intended to be non-limiting, illustrates a model according to one at least one embodiment that uses inheritance and consequently specialization. In this model ATTR 1 is a primal field and ATTR 3, ATTR 6 and ATTR 9 are its secondary fields and ATTR 1, ATTR 3, ATTR 6 and ATTR 9 are its implementations. In addition to this, ATTR 3 is an upper implementation of ATTR 9 and all primal fields are PATH 1, PATH 2, PATH3, PATH 4, PATH 5, PATH 6, ATTR 1, ATTR 2, ATTR 5, ATTR 8, ATTR 11, ATTR 14 and ATTR 15, all other fields are secondary. Examples of deep inheritance are PATH 7 and PATH 8 since they inherit from the paths that they specialize. If in this model the polymorphic dominance associated with the primal field ATTR 11 would be
Dominance(ATTR 13)=0 and
Dominance(ATTR 12)=1 and
Dominance(ATTR 11)=2
   and an entity was a member of PATH 6, PATH 7 and PATH 8 at the same time and smaller dominance numbers indicate a more dominant implementation, then the implementation to use to derive the polymorphic value of ATTR 11, ATTR 12 and ATTR 13 of that entity would be ATTR 13 since it would be the most dominant current implementation.

### 5.1.8 Different Kinds of Paths (FIG. 18)

According to one preferred embodiment there are three kinds of paths; “atomic”, “subset” and “link”. Atomic paths instantiate new atomic entities, in response to a request by the user or an action and with the currently selected subject as its parent, who immediately become members of the path after instantiation. Subset paths have an associated formula used to calculate the “targets” of a subject, a set of entities derived from the subject by calculation that preferable be descendants of that subject and may then become members. The targets of link paths do not have to be descendants of their subjects, so in order to maintain an ancestor-entity-in-parent-path-arrangement they generate combined identities, by combining the subjects with their targets, which then may become members of the path. Specializations of respectfully atomic, subset or link paths are also atomic, subset or link paths and subset and link paths are collectively referred to as “derived paths” because they have formulas. Those skilled in the art will appreciate that when the targets of subset paths are descendants of their subjects, embodiments may filter them or refuse the provided formula. The fact that user can add fields to link paths enables a featured called “link typing”.

FIG. 18, which is intended to be non-limiting, illustrates a model according to one at least one embodiment wherein all paths are atomic, except the paths RETIRED PERSONS and EMPLOYEES who are respectfully a subset—and link path because the targets of the former are descendants of its subjects while the targets of the latter are not, presuming that their formulas are “X->WHERE(X.PERSONS, P->P.AGE>65)” and “X->X.PARENT.PERSONS”. The targets of RETIRED_PERSONS for subject “1” are “1.3” and the targets for EMPLOYEES for subject “1.4” are “1.1” and “1.2”, and the targets for EMPLOYEES for subject “1.5” are “1.1”.

FIG. 18 further illustrates how embodiments may hide or show an attribute based on the state of an entity. For example, when looking at a person though a user interface, the attribute feels may only be shown when that person is a member of the path RETIRED_PERSONS.

According to a further alternative embodiment of the invention there is provided
a method for determining the visual state of an input widget that is associated with an attribute in the system for an entity in said system; or
a non-transitory computer readable medium embodying information indicative of instructions that when executed by a calculation device in a data system perform said method,
   wherein
said system comprises a calculation device, a storage device and a display device and
said widget is part of a user interface that is displayed on said display device,
   said method comprising
determining if said attribute has an implementation under one of the current paths of said entity; and
hiding or displaying said widget in a disabled visual state on said user interface when no such implementation is found, or alternatively, when such an implementation is found, displaying said widget in an enabled visual state on said user interface,
   wherein possibly
said entity is a member of a child path and has a parent entity that is a member of the parent path of said child path; or
at least one path under which at least one implementation of said field is present, is associated with a formula that calculates its targets.

This make the user interface more flexible in adapting to the correct visual display state in order to assist the user.

### 5.1.9 Displaying Identities (FIG. 19)

According to a further alternative embodiment of the invention there is provided
a method for visually displaying the identity of a child entity in the data system comprising a display device; or
a non-transitory computer readable medium embodying information indicative of instructions that when executed by a calculation device in a data system perform said method,
   said method comprising
displaying a sequence of characters on said display device comprising the identities of the parent entities of said child entity
   wherein possibly
said child entity is a member of a path in said data system; or
said child entity has at least one parent entity; or
said parent entity is a member of the parent path of said path in said data system; or
said path has an attribute.
   And additionally, it may further be that
said child entity is a member of two paths in said data system; or
one of the paths in said two paths inherits from the other path in said two paths; or
said attribute is associated with a formula that the user can alter.

FIG. 19, which is intended to be non-limiting, illustrates such a situation wherein the identity of the child entity is formed out of the identities of its parent entities.

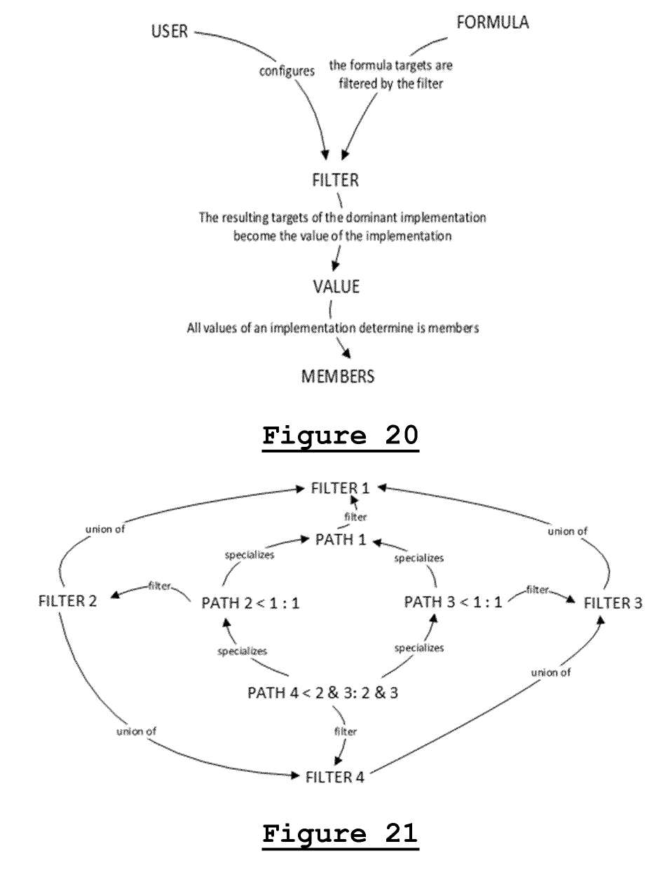

### 5.1.10 Polymorphic Value (FIGS. 20-25)

According to a further alternative embodiment of the invention there is provided
a method for calculating a subject's polymorphic value for a derived primal path's implementation; or
a non-transitory computer readable medium embodying information indicative of instructions that when executed by a calculation device in a data system perform said method
   said method comprising
determining the primal field's dominant current implementation of the subject; and
calculating said polymorphic value as the non-polymorphic value for that dominant implementation of the subject by
   calculating the subject's targets for that dominant implementation by filtering its “formula targets” with its “filter” for that subject; and
   when the path is a link path, creating or locating for each obtained target a new or existing combined identity with as left parent that subject and as right parent the target
      wherein a subject's “formula targets” and “filter” for a derived path implementation are respectfully
the entities obtained by applying the implementation's formula to the subject; and
a filter that the user can configure by setting its default rule to pass or block all possible targets and by adding exceptions to that default rule.

A filter configured to let all possible targets through and has no exceptions is called a “pure-pass-through filter”. When the filter of a subset path is not mentioned, it can be presumed that it is a pure-pass-through filter. The resulting targets or combined identities then become members of the derived path implementation. In contrast, calculating a subject's value for an atomic primal path's implementation consist out of all atomic children that where instantiated by an implementation of that primal path for that subject. FIG. 20, which is intended to be non-limiting, illustrates according to one at least one embodiment how the values of derived path implementations are calculated.

Those skilled in the art will appreciate that non-polymorphic value of a field is the value of the field as it would be calculated in a system that lacks polymorphism.

Those skilled in the art will appreciate that the values, and thus members, of each implementations of a primal path for an entity is determined by the same dominant implementation of that primal path, and thus is the same for each such current implementation! This enabled a feature called “super-positioned memberships”. As an example of super-positioned memberships, consider the following model:

/DATASETS/PERSONS/CARS/ATTR1
/DATASETS/RETIRED_PERSONS/CARS/ATTR2
/DATASETS/WEALTHY_PERSONS/CARS/ATTR3

wherein

| - RETIRED_PERSONS and WEALTHY_PERSONS inherit from | |
|---|---|
| PERSONS and | |
| - /DATASETS/RETIRED_PERSONS/CARS and | |
| /DATASETS/WEALTHY_PERSONS/CARS | specialize |
| /DATASETS/PERSONS/CARS, | |

when an instance of PERSON also becomes an instance of RETIRED_PERSONS and WEALTHY_PERSONS, the cars of that instance will be members of /DATASETS/PERSONS/CARS,
/DATASETS/RETIRED_PERSONS/CARS and /DATASETS/WEALTHY_PERSONS/CARS and thus will have the fields ATTR1, ATTR2 and ATTR3, independent of which implementation of CARS is dominant.

Those skilled in the art will appreciate that the filters of a derived path implementation can be represented as sets of exceptions per subject, making the operation union and intersection applicable to them. Consequentially, the filters of derived path implementations may be defined as combinations, e.g. the union or intersection, of the filters of other implementations, called the “source implementations”.

According to a further alternative embodiment of the invention there is provided
a method to calculate the exceptions in a filter associated with a derived path for a subject
a non-transitory computer readable medium embodying information indicative of instructions that when executed by a calculation device in a data system perform said method,
   wherein
said filter that has associated source implementations
   said method comprising
calculating the union of the exceptions in the filters of said associated source implementations for said subject or alternatively
calculating the intersection of the exceptions in the filters of said associated source implementations for said subject
   depending on how said derived path is configured. This makes the system mush more flexible then conventional data systems.

Preferred embodiments prevent the user is from making these combinations cyclic and when a user asserts add an exception to a filter the exception is added to all filters of its source implementations. Besides this, preferred embodiments allow the formulas of lower implementations to be defined as a combination of their upper implementations, e.g. union, intersection, complement or xor. The combining of filters and formulas allow implementations to have the same value for each of their subjects, these implementations are called “proxies”.

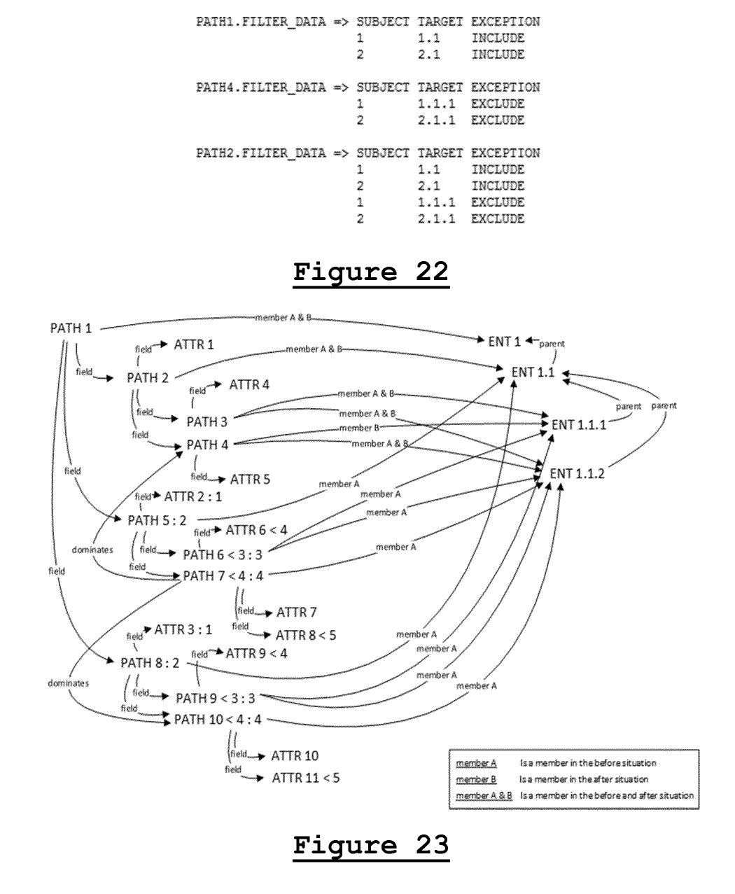

FIG. 21, which is intended to be non-limiting, illustrates according to one at least one embodiment how the filter of several implementations is the union of the filter of other implementations. FIG. 22, which is intended to be non-limiting, illustrates according to one at least one embodiment how the data in those filters may look.

FIG. 23, which is intended to be non-limiting, illustrates according to one at least one embodiment how the members of a path are influenced by the current fields of the subject. It depicts a before and after situation of a model and associated data wherein PATH 1, PATH 2 and PATH 3 are atomic and wherein all implementations of the primal fields PATH 3, ATTR 1, ATTR 4 and ATTR 5 are proxies and wherein PATH 5, PATH 8, PATH 4, PATH 7 and PATH 10 are subset paths with a pure pass through filter and with the following formulas

PATH5.formala=“WHERE(PATH2, P2->P2.ATTR1>5)” and

PATH8.formala=“WHERE(PATH2, P2->P2.ATTR1>6)” and

PATH4.formala=“WHERE(PATH3, P3->P3.ATTR4>8)” and

PATH7.formala=“WHERE(PATH6, P6->P6.ATTR6>10)” and

PATH10.formala=“WHERE(PATH9, P9->P9.ATTR9>12)”

and wherein ATTR 1, ATTR 4 in the before situation have the values

ATTR1.values={1.1:3}

ATTR4.values={1.1.1:9, 1.1.2:9}.

By changing the value of ATTR1 for entity 1.1 to 10, called the after situation, the value of PATH 4 and PATH 10 for subject 1.1 is now determined by PATH 7 who is now the current dominant implementation, and consequentially in the after situation entity 1.1.1 is no longer a member of PATH 4 and the current fields of entity 1.1.2 are ATTR 5, ATTR 7, ATTR 8, ATTR 10 and ATTR 11.

According to a further alternative embodiment of the invention there is provided
a method for calculating a subject's value for a primal attribute's implementation; or
a non-transitory computer readable medium embodying information indicative of instructions that when executed by a calculation device in a data system perform said method,
   said method comprising
calculating the primal field's dominant current implementation of the subject; and
calculating the subject's “formula value” for that dominant implementation; and
calculating said values as the subject's value for that dominant implementation by returning the “formula value” or its “overridden value”,
   wherein a subject's “formula value” and “overridden value” for an attribute implementation are respectfully
the value obtained by applying the implementation's formula to the subject; and
an independent value that may be provided by the user that overrides the formula value of a subject.

When a user has supplied a value for an attribute that does not have an associated formula, this value is still designated as an overridden value.

Those skilled in the art will appreciate that overridden values of implementations can be defined as “generalized union” of overridden values of other implementations, called the “source implementations”. A generalized union of a set of equal values is that value, or NULL if the values are not equal. Preferred embodiments prevent the user is from making these generalized unions cyclic and when a user sets an overridden value to an implementation, the overridden value is set for all of its source implementations. Besides this, preferred embodiments allow the formulas of lower implementations to be defined as a one of their upper implementations. The generalized union and formula sharing also allow attribute implementations to have the same value for each of their subjects, in other words they allow for proxies.

The sharing of exceptions in filters or overridden values between different implementations of primal paths or attributes is in general referred to as a feature called “implementation data-sharing”.

Those skilled in the art will appreciate that the dominant implementation of a field may change over the life time of an entity, a feature enabling “inter-life-time polymorphism”.

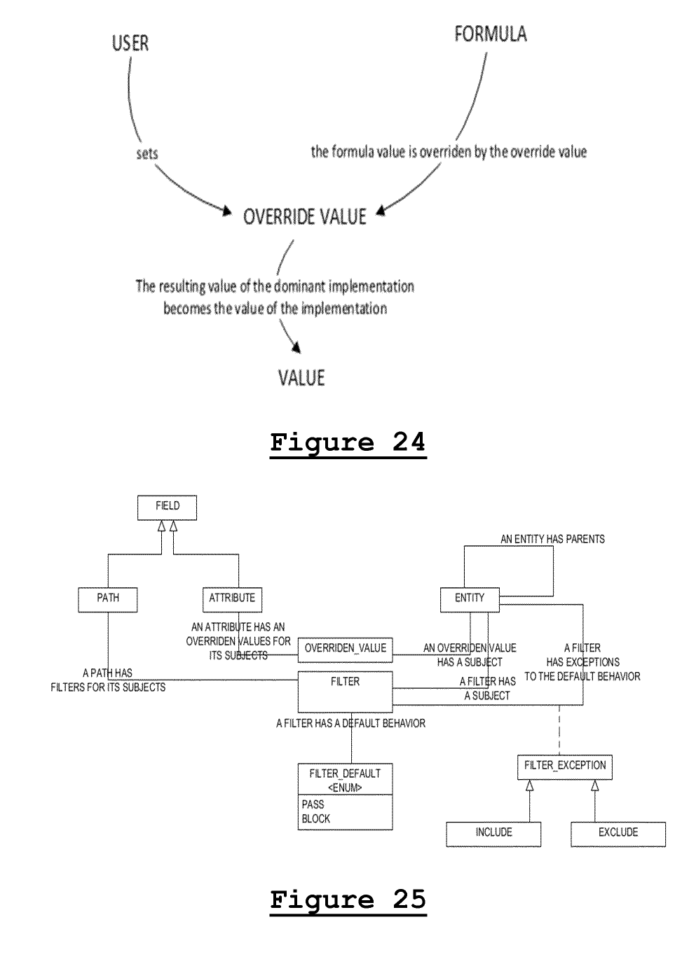

FIG. 24, which is intended to be non-limiting, illustrates according to one at least one embodiment how the value of attribute implementations may be calculated.

FIG. 25, which is intended to be non-limiting, illustrates according to one at least one embodiment how the non-calculated data of the system may be structured. Embodiments may choose to also store the calculated values in the system as an optimization.

FIG. 26, which is intended to be non-limiting, illustrates according to one at least one embodiment an example of inter-life-time polymorphism. When in the following model

```
/DATASETS/ANIMALS/IS_DOG
/DATASETS/ANIMALS/IS_CAT
/DATASETS/ANIMALS/SOUND_PRODUCED
/DATASETS/DOGS.formula  =  WHERE(ANIMALS,  A  ->  A.IS_DOG)
/DATASETS/DOGS/SOUND_PRODUCED.formula = “waff”
/DATASETS/CATS.formula  =  WHERE(ANIMALS,  A  ->  A.IS_DOG)
/DATASETS/CATS/SOUND_PRODUCED.formula = “miauw”
wherein  DOGS  and  CATS  inherit  from  ANIMALS  and  -
      -  /DATASETS/CATS/SOUND_PRODUCED  dominates
      -  /DATASETS/DOGS/SOUND_PRODUCED  which  dominates
      -  /DATASETS/ANIMALS/SOUND_PRODUCED
```

the user sets the attribute IS_DOG of entity “1.3” to true, its dominant implementation of the SOUND_PRODUCED attribute will have the constant formula “waff”, if subsequently the sets the attribute IS_CAT of entity “1.3” to true, its dominant implementation of the SOUND_PRODUCED attribute will have the constant formula “miauw”. This a good example of inter-life-time polymorphism.

According to a further alternative embodiment of the invention there is provided,
a method for calculating the polymorphic value of a field for an entity in the system comprising a storage device and a calculation device,
a non-transitory computer readable medium embodying information indicative of instructions that when executed by a calculation device in a data system perform said method
   said method comprising
calculating the most dominant implementation of the primal field of said field in the current fields of said entity and
calculating said polymorphic value as the none-polymorphic value of said dominant implementation for said entity
   wherein
when said field is an attribute with an associated formula, then
   if said dominant implementation does not has an overridden value for said entity, said polymorphic value is the calculated value of said dominant implementation for said entity and
   when said dominant implementation shares its overridden values with two other implementations, its overridden value for said entity is the overridden value of those two other implementations for said entity if they are equal or, if they are different it is the last overridden value set on one of those two other implementations for said entity or NULL or unknown and
when said field is a path with an associated formula, then
   when said dominant implementation shares its filter with others implementations, said polymorphic value is determined by filtering its formula targets with the combined filter from those other implementations
      wherein further possibly
said current fields comprise two implementations of the primal field of said field.

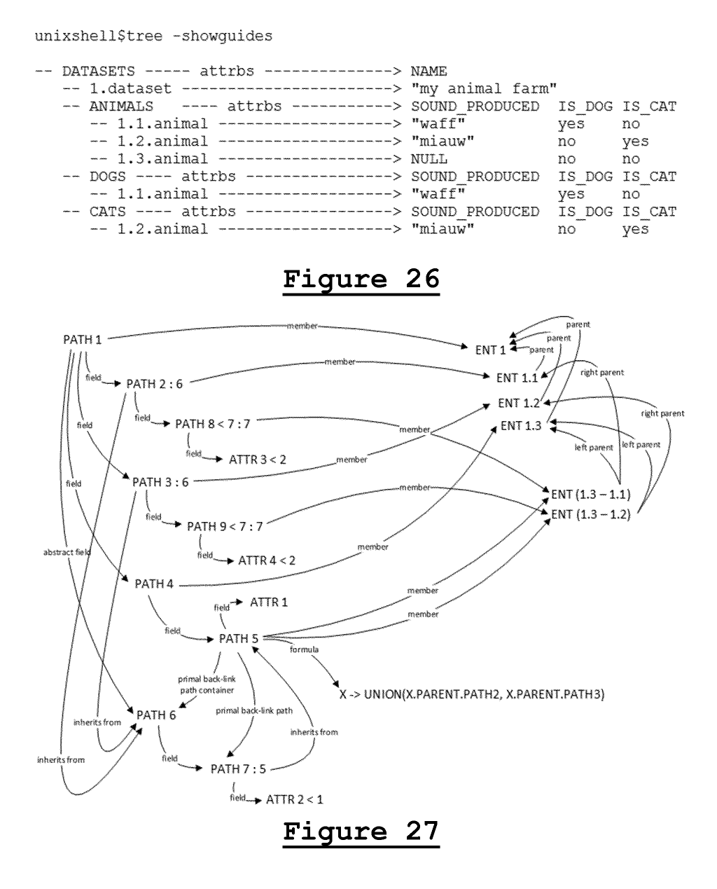

### 5.1.11 Back-Link Paths (FIG. 27)

According to one preferred embodiment, a subject's targets for a primal link path preferably has a means for referencing all subjects of which they are a target, in other words the relationship preferably is bidirectional. This can be realized by defining on each path whose members can be targets of that primal link, called a “target path”, a path whose value for a subject is all combined identities whose right patent is that subject and are members of an implementation of that primal link path, this new kind of path is called a “back-link path”. We also say that link paths “link to” their target paths. Back-link paths enable a feature called “native bidirectional relationships”. This can be implemented by associating with each primal link path one primal back-link path and adding its implementations to the target paths through inheritance. In order to do this a “primal back-link path container,” an abstract path on which the primal back-link path is defined, is created and each target path inherits from this path. “Abstracts path” will never have any members and preferred embodiments may hide them from the users. Those skilled in the art will appreciate that these primal back-link paths inherits from their associated primal link paths and thus all targets paths' implementations of these primal back-link paths will have implementations for each attribute and sub-path defined on the primal link path causing the fields defined on combined identities to have polymorphic behaviour on both the left and right parent, a concept known as “double dispatch” in the art of the field of object-oriented programming.

FIG. 27, which is intended to be non-limiting, illustrates such an embodiment. PATH 1, PATH 2, PATH 3 and PATH 4 are atomic and PATH 5 is a primal link path with target paths PATH 2 and PATH 3, both of these target paths inherit from the primal back-link path container PATH 6 who contains PATH 5's primal back-link field PATH 7. In the remained of this text back-link paths may be implied even though they may not be explicitly mentioned or depicted.

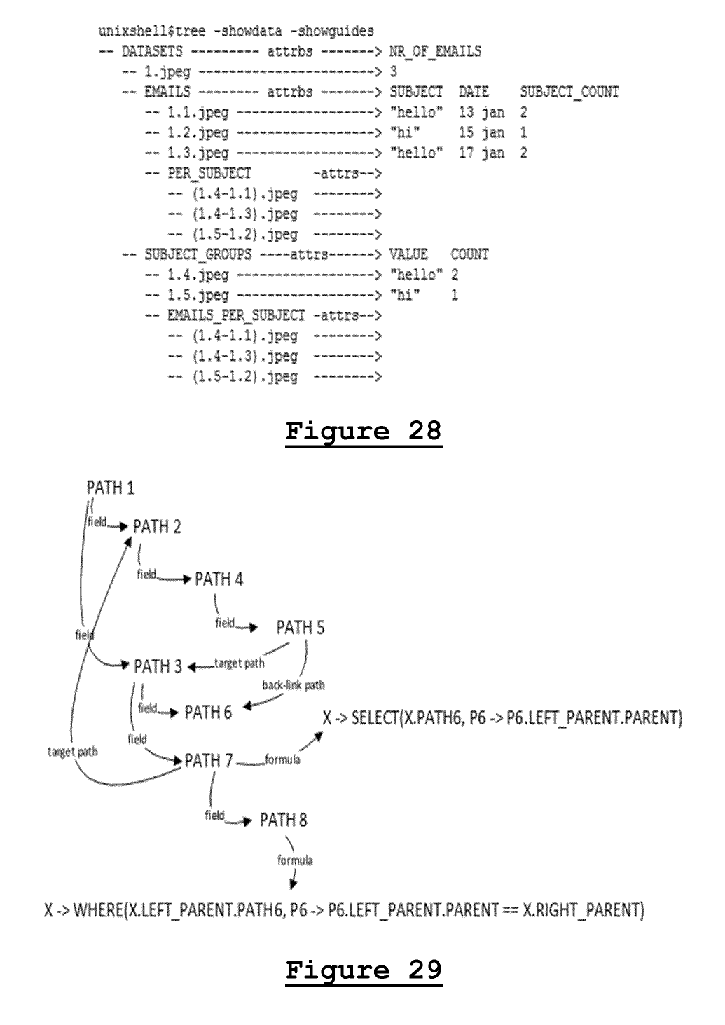

### 5.1.12 Grouping (FIGS. 28-29)

According to one preferred embodiment atomic paths may have an associated formula that returns a set of scalar values for each subject causing the atomic path to instantiate one atomic entity for each such unique value and associate that value with that entity, called “value entitization”. When the value of the formula changes and it no longer contains some scalar value for which an entity has been creates, then that entity is deleted or flagged as such. Those skilled in the art will appreciate that this allows users of the system to group entities and aggregate over these groups, leading the system to realize behaviour similar to OLAP cubes.

FIG. 28, which is intended to be non-limiting, illustrates an example application according to one at least one embodiment in which the paths SUBJECT_GROUPS and EMAILS_PER_SUBJECT have the formulas “X->SELECT(X.EMAILS, E->E.SUBJECT)” and “X->WHERE(X.PARENT.EMAILS, E->E.SUBJECT=X.VALUE)”, the emails are effectively grouped by subject. Through the back-link path PER_SUBJECT, the subject count can be calculated for each email, e.g. by defining the field SUBJECT_COUNT with formula “X->X.PER_SUBJECT.COUNT”.

FIG. 29, which is intended to be non-limiting, illustrates according to one at least one embodiment how the members of a PATH 6 can be grouped by PATH 2 in a similar way. Preferred embodiments would allow users to do these two steps in one instruction.

According to a further alternative embodiment of the invention there is provided
a method for grouping entities under a path in a data system comprising a calculation device and a storage device; or
a non-transitory computer readable medium embodying information indicative of instructions that when executed by a calculation device in a data system perform said method
   said method comprising
creating an entity under a further path for every unique value of an attribute under said path; and
calculating a value of an attribute under said further path, for a member of said path, in function of one of said unique values

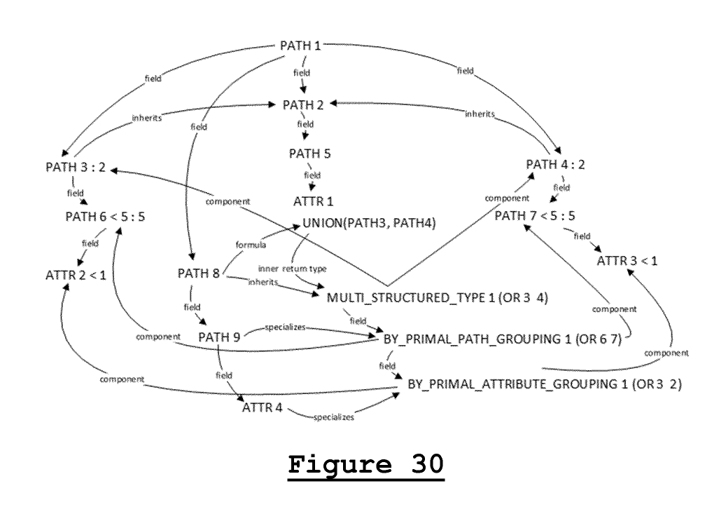

### 5.1.13 Type Inference (FIGS. 30-32)

According to one preferred embodiment, models are verified for correctness though static typing wherein an error is reported to the user when that formula references a field that does not exist. A recursive type inference method, executed by a “type inference engine”, may be employed with scalar types, structured types and set types wherein a set type has an inner type that is a scalar or structured type, fields and formulas have a return type, structured types have fields and a path is both a structured type and a field. The “inner return type” of a field or formula is the inner type of its return type when that return type is a set type or the return type itself otherwise, and the inner return type of every field that is a path, is itself. In more specifically, the return type of a multi path is a set type with as inner type said path and the return type of a single path is itself.

According to at least one preferred embodiment, a “multi-structured” type is a structured type that represents multiple other structured types, called “components”, combined in an and- or or-fashion, enabling a feature called “union and intersection typing”. Multi-structured types have “by-primal-grouping” fields that represent multiple implementations of the same primal field, combined in an and- or or-fashion. By-primal-grouping fields have the same fashion as their multi-structured type and are formed by grouping all fields of the components of their multi-structured type by their primal fields. Or-fashioned, by-primal-grouping fields are deactivated when their primal field does not have an implementation in each component of their multi-structured type, in contrast and-fashioned, by-primal-grouping fields are not. By-primal-grouping fields whose primal field is a reference, attribute or path are respectfully called “by-primal-reference-grouping”, “by-primal-attribute-grouping” and “by-primal-path-grouping”. A by-primal-path-grouping field is a structured type whose fields are again by-primal-grouping fields.

According to at least one preferred embodiment, a path may inherit from multiple structured types and this is realized by associating every path with one and-fashioned, multi-structured type, called the “inheritance multi-structured” type of which all inherited structured types are components, and creating one specialized field on that path for each by-primal-grouping field in that inheritance multi-structured type. This way, when a path inherits from multiple structured types that each have different implementations of the same primal field, those implementations are automatically grouped into one by-primal-grouping field and secondary fields only need to specializes this one by-primal-grouping field. When a path inherits from a structured type, the inheritance may be explicit or implicit. An explicit inheritance is user controlled, the user has added it and may remove it, implicit inheritance is controlled by the system, e.g. a link path's target paths inherit implicitly from that link path's back-link container. Subset paths inheriting from the inner return type of their formula enables a feature called “Formula inheritance” and is a form of implicit inheritance. Target paths inheriting from back-link containers and specializations implying inheritance are other forms of implicit inheritance.

FIG. 30, which is intended to be non-limiting, illustrates according to one at least one embodiment union typing in a model that uses a multi-structured type to realize a subset path implicitly inheriting from its formula. In the example model, PATH 2 is field of PATH 1 and its return type is itself or a set type with as inner type itself, depending on whether it is a single or multi path. The inner return type of the formula of the subset-path PATH 8 is MULTI_STRUCTURED_TYPE 1 with components PATH 3 and PATH 4 and consequentially one grouping field, BY_PRIMAL_PATH_GROUPING 1 with components PATH 6 and PATH 7 and one grouping field, BY_PRIMA_ATTRIBUTE_GROUPING 1 with components ATTR 2 and ATTR 3. PATH 8 implicitly inherits from the inner return type of its formula resulting in PATH 9 which specializes BY_PRIMAL_PATH_GROUPING 1 and thus is an implementation of PATH 5. Because specialization implies inheritance PATH 9 also inherits from BY_PRIMAL_PATH_GROUPING 1 resulting in ATTR 4 which is an implementation of ATTR 1.

According to a further alternative embodiment of the invention there is provided
a method for calculating the fields of a path; or
a non-transitory computer readable medium embodying information indicative of instructions that when executed by a calculation device in a data system perform said method,
   said method comprising
calculating the reference fields of said path; and
calculating the none-reference fields of said path; and
calculating the fields of said path as the union of said reference fields and none-reference fields,
   said method possibly further comprising
calculating the reference fields of atomic paths as
   a parent field whose return type is the parent path of that path; and
   a root field whose return type is the root path of the model; and
calculating the reference fields of subset paths as
   a proxy field for each reference field in the inner return type of its formula; and
calculating the reference fields of link paths as
   a left parent field whose return type is the parent path of that path; and
   a right parent field whose return type is the inner return type of its formula; and
   a root field whose return type is the root path of the model and
calculating the reference fields of back-link paths as
   a left parent field whose return type is the parent path of its primal link-path and
   a right parent field whose return type is the parent path of that path and
   a root field whose return type is the root path of the model and
calculating the none-reference fields as
   said paths' primal fields; and
   a specialization for each by-primal-grouping in the path's inheritance, multi-structured type.

According to a further alternative embodiment of the invention there is provided
a method to determine the fields of a path that has primal fields and inherits from at least two base paths, in a type inference engine comprising a storage device and a calculation device; or
a non-transitory computer readable medium embodying information indicative of instructions that when executed by a calculation device in a data system perform said method
   said method comprising
determining the base paths' fields; and
grouping said base paths' fields by their primal field; and
creating specialized fields on said path, one for each such group; and
determining the fields of said path by unioning said primal fields of said path with said specialized fields,
   and optionally
creating reference fields on said path; or
determining the fields of said path by unioning said primal fields of said path with said specialized fields and said reference fields,
   wherein possibly
said path is atomic and creating said reference fields comprise creating a parent field whose return type is the parent path of said path; or
said path is a subset path with an associated formula and creating said reference fields comprise creating a proxy for each reference field in the inner return type of said formula; or
said path is a link path with an associated formula and creating said reference fields comprise creating a left parent reference field whose return type is the parent path of said path and a right parent reference field whose return type is the inner return type of said formula.

This method allows multiple inheritance in a system that supports typed collection, which makes it much more flexible.

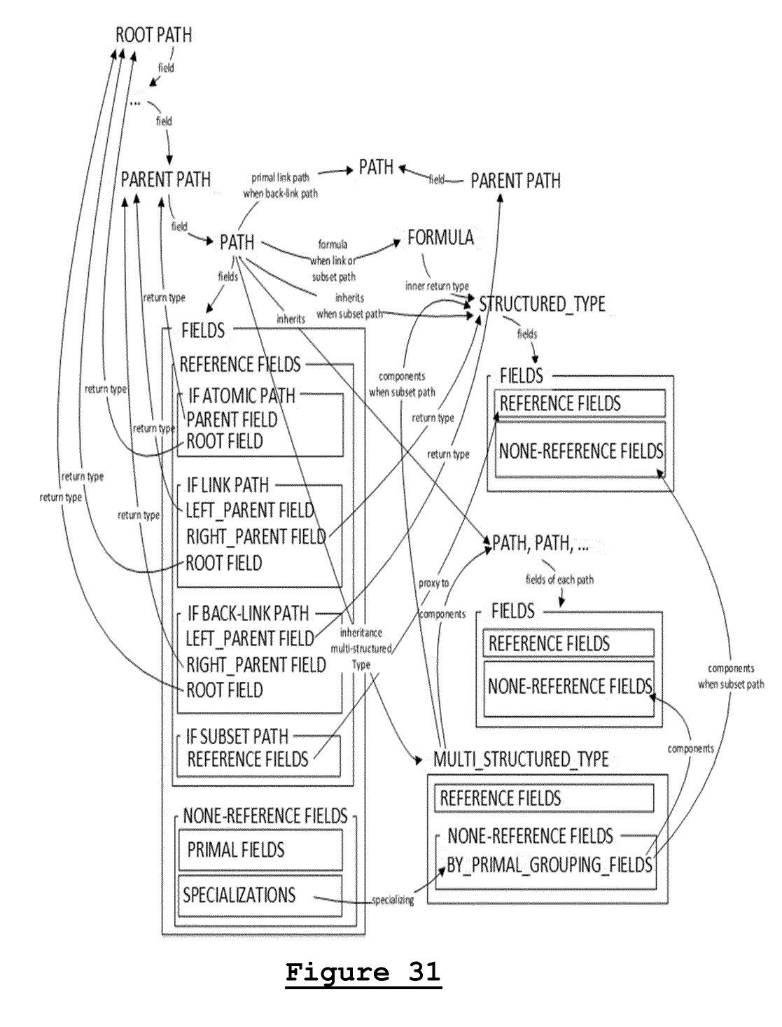

FIG. 31, which is intended to be non-limiting, provides an overview of this recursive type inference system according to one at least one embodiment.

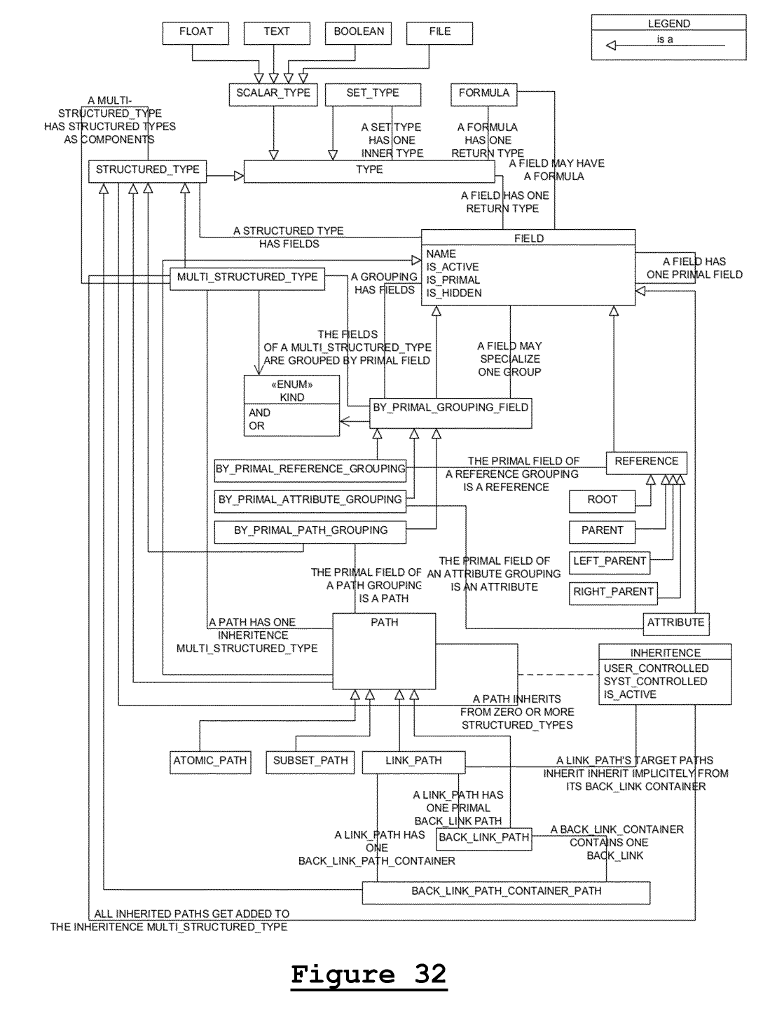

FIG. 32, which is intended to be non-limiting, illustrates one way to structure such a recursive type inference system according to one at least one embodiment.

According to a further alternative embodiment of the invention there is provided
a method for adding a structured type to a multi-structured type; or
a non-transitory computer readable medium embodying information indicative of instructions that when executed by a calculation device in a data system perform said method,
   said method comprising
determining all fields of that structured type
adding each such field to the by-primal-grouping field with corresponding primal field or creating a new by-primal-grouping field with the primal field of said field and adding the field to that by-primal-grouping field

Inversely, according to a further alternative embodiment of the invention there is provided
a method for removing a structured type from a multi-structured type;
a non-transitory computer readable medium embodying information indicative of instructions that when executed by a calculation device in a data system perform said method,
   said method comprising
determining all fields of that structured type
removing each such field from to the by-primal-grouping field with corresponding primal field

In said alternative embodiments, it is preferable that
when a user deletes a field, it is deactivated; and
when a user resurrects a field, it is reactivated; and
when a path of is inactive, so are its fields; and
when a field is inactive so are its lower implementations; and
when a link path is deactivated so is its back-link path container; and
a and-fashioned by-primal-field-grouping is active when it contains one active field; and
a or-fashioned by-primal-field-grouping is active when it contains one active field for each structured type in components of the multi-structured-type to which it belongs; and
when a base path of a path is deactivated, it is removed from the inheritance multi-structured type.

These methods enable incremental type checking which make the type inference engine much faster.

According to the preferred embodiment, the return type of a formula can be calculated in a recursive manner by examining its AST and determining the return type of each expression based on the return types of the variable and sub-expression used in it, similar to other well-known type inference algorithms such as Hindler-Milner or open source C# lambda type inference.

According to a further alternative embodiment of the invention there is provided
a method for calculating the return type of a formula,
a non-transitory computer readable medium embodying information indicative of instructions that when executed by a calculation device in a data system perform said method
   said method comprising
calculation said return type in function of
   calculating a return type as the return type of the outer scope variable as the parent path of the field to who the formula belongs; and
   calculating a field expression's return type as the return type of the field; and
   calculating a “UNION” and “XOR” function's return type as a set type whose inner type is an or-fashioned multi-structured type with the inner return types of arguments of the function as its components; and
   calculating an “INTERSECTION” function's return type as a set type whose inner type is an and-fashioned multi-structured typed with the inner return types of arguments of the function as its components; and
   calculating a “COMPLEMENT” function's return type as a the return type of its first argument; and
   calculating a “WHERE” function's return type as the return type of its first argument and the return type of the variable that is introduced in the lambda of its second argument is the inner return type of first argument; and
   calculating a “SINGLE” function's return type as the inner return type of its first argument and the return type of the variable that is introduced in the lambda of its second argument is the inner return type of first argument and
   calculating a “SELECT” function's return type as the return type of its second argument and the return type of the variable that is introduced in the lambda of its second argument is the inner return type of first argument; and
   calculating a “SELECT_MANY” function's return type as the return type of its second argument and the return type of the variable that is introduced in the lambda of its second argument is the inner return type of first argument and
   calculating the return types of “ADD”, “SUB”, “MUL”, “DIV”, “SUM”, “AVR”, “MIN”, “MAX”, “FIRST” and “LAST” as FLOAT; and
   calculating the return type of “NOT”, “AND”, “OR”, “EQUALS”, “LIKE”, “SMALLER_THAN” and “GREATER_THAN” as BOOLEAN.

According to a further alternative embodiment of the invention there is provided
a method for validating that a formula of a subset path only returns entities that are descendants of its subjects,
a non-transitory computer readable medium embodying information indicative of instructions that when executed by a calculation device in a data system perform said method
   said method comprising
testing that the expressions in said formula that may contribute elements to its values only reference paths that are descendants of the parent path of the field on which said formula is defined.

For example, in the following model

DATASETS/EMPLOYEES/SALARY
DATASETS/COMPANIES/WEALTHY_EMPLOYEES

with the formula “X->SUM(X.PARENT.EMPLOYEES, E->E.SALARY>3000)”, defined on WEALTHY_EMPLOYEES, fails this test since an expression that may contribute to the elements of the value of this formula, e.g. “X.PARENT.EMPLOYEES” references paths that are not descendants of the path DATASETS/COMPANIES, being “DATASETS” and “DATASETS/EMPLOYEES”. The expressions that may contribute to the elements of the value of a formula are identified by reclusively following the underlined sub-expressions of the following expressions:

- SUM(<left expression>, <right expression>)
- WHERE(<left expression>, <right expression>)
- SELECTMANY(<left expression>, <right expression>)
- SELECT(<left expression>, <right expression>)
- UNION(<left expression>, <right expression>)
- XOR(<left expression>, <right expression>)
- INTERSECTION(<left expression>, <right expression>)
- COMPLEMENT(<left expression>, <right expression>)
- IF(<condition expression>, <then expression>, <else expression>)
- LAMBDA: X -> <sub-expression>

Other expressions are similar.

According to at least one preferred embodiment, a formula may create fields on the path to which it belongs. As an example, the formula

“X->SQL(some_servername,‘employees_table’,‘select*from employees_table where department_id=’+x.department_id)”

may ask the server “some_server” for the columns of table “employees_table” and create associated attributes for each such column on the path on which it is defined. At runtime, it will create one row for each record and associate values to those records for each such attribute. This is one example of a formula that connects to an external system, other examples include; connecting to an email server, connecting to file system, connecting to an xml database, and so forth. These formulas are called “import formulas” and they may register themselves with a timer in the system that pull fresh data on regular interval, or they may register listeners with their sources, such as installing triggers on database tables. Alternatively, embodiments may provide specialized paths for importing and exporting data to external systems; such as an SQL_IMPORT path or an EMAIL_IMPORT path or an XML_EXPORT path and so forth, which can then be configured by the user with the correct setting and credential to access the external systems.

Those skilled in the art will appreciate that will appreciate that although fields that are automatically create by the system may be created in a lazy fashion, the fields are considered “created” from the moment they can be used in a formula.

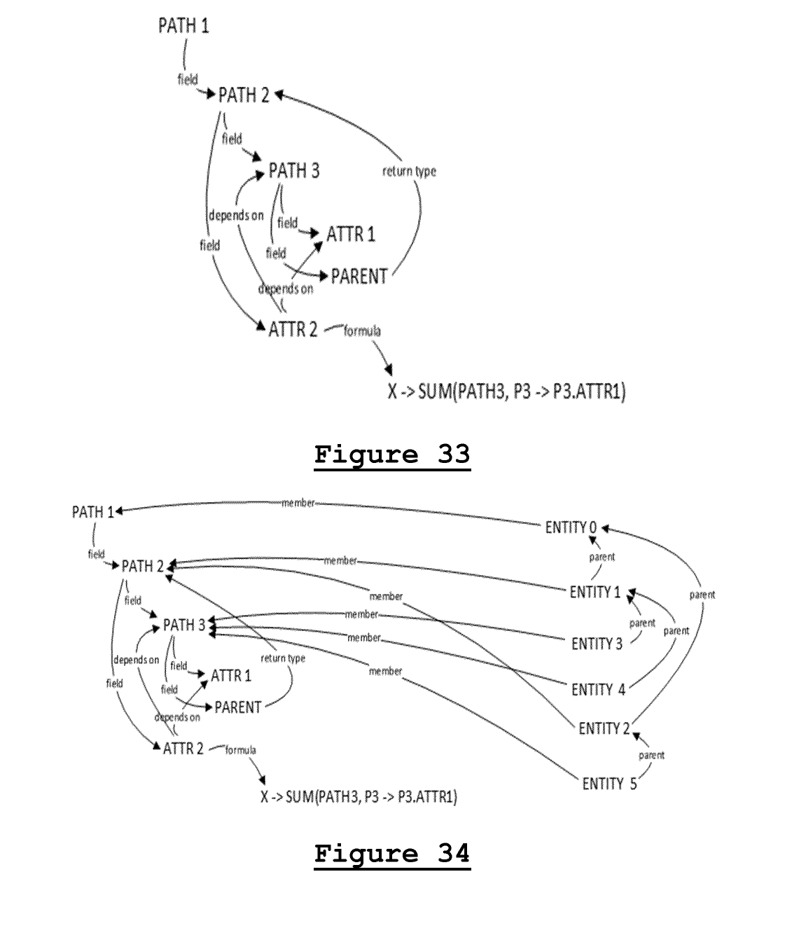

### 5.1.14 Modelling Features Capabilities (FIGS. 33-37)

FIGS. 33 to 37, which are intended to be non-limiting, illustrate some of the modelling features that the type inference engine, runtime engine and the data system as a hole possess and how embodiments can be tested for these features.

According to a further alternative embodiment of the invention there is provided
A method in a data system comprising a storage device and a calculation device; or
a type inference system in a data system comprising a storage device and calculation device; or
a non-transitory computer readable medium embodying information indicative of computer executable instructions that when executed by a calculation device forms a data system; or
a node in a data system embodied in a client-server architecture or peer-to-peer architecture, said node comprising a storage device, a calculation device and a communication device suited for network communication that behaves as specified in FIGS. 33 to 37.

FIG. 33, which is intended to be non-limiting, shows a model that is obtained after an agent has instructed said embodiment of the system to
create a first path and
create a second path, under said first path and
create a third path, under said second path and
create a first attribute, under said third path, that has a numeric value and
create a second attribute, under said second path, that has is numeric value and associated with a formula that is dependent on said third path and said first attribute
   causing said system to
execute each instruction successfully and
to create a reference field under said third path whose return type has an implementation of said second attribute, indicating that the type inference engine of said system supports by-value typed collections, reference fields and calculated fields which causes the technical effects of reduced memory consumption, increased flexibility and accelerated data retrieval.

FIG. 34, which is intended to be non-limiting, shows a model with data that is obtained from the model in FIG. 33, after an agent has instructed that same embodiment of the system to
create a first entity, under said second path and
create a second entity, under said second path and
create a third entity whose parent is said first entity, under said third path and
create a fourth entity whose parent is said first entity, under said third path and
create a fifth entity whose parent is said second entity, under said third path causing said system to
execute each instruction successfully and
to create a reference field under said third path whose return type has an implementation of said second attribute indicating that the runtime engine of said system supports by-typed collections, reference fields and calculated fields which causes the technical effects of reduced memory consumption, increased flexibility and accelerated data retrieval.

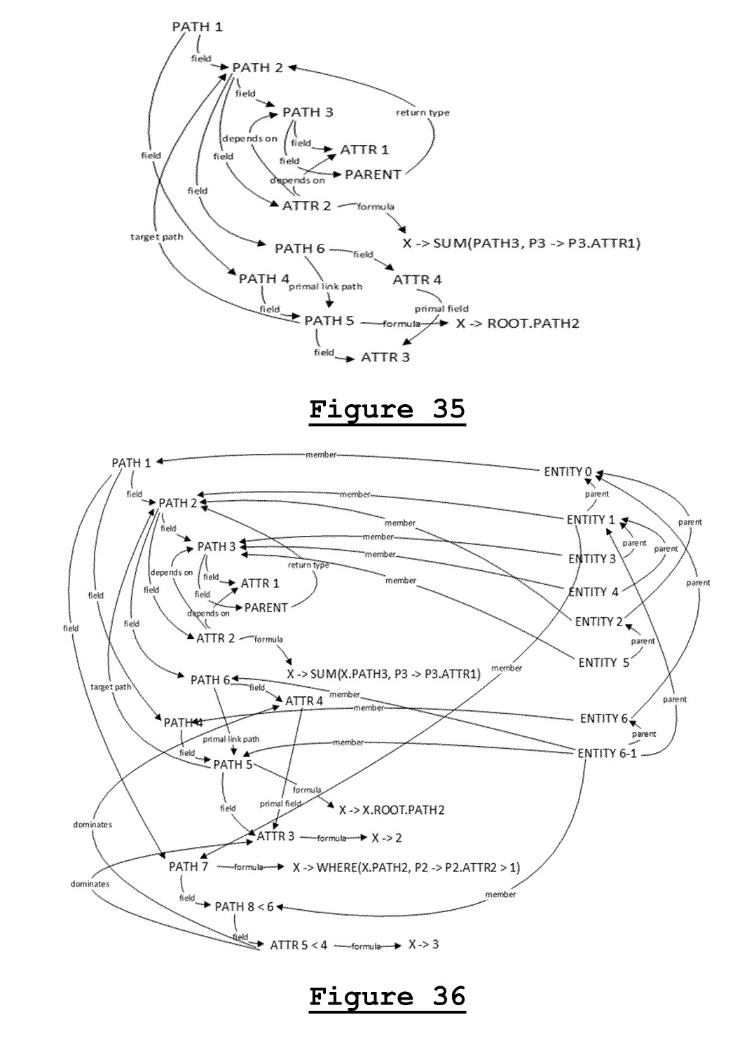

FIG. 35, which is intended to be non-limiting, shows a model with data that is obtained from the model in FIG. 33, after an agent has instructed that same embodiment of the system to
create a fourth path, under said first path and
create a fifth path, under said fourth path, that links to said second path and
create a third attribute, that is numeric, under said fifth path
   causing said system to
execute each instruction successfully and
create a sixth path under said second path and
create a fourth attribute under said sixth path, that is an implementation of said third attribute
   indicating that the inference engine of said system supports native bidirectional relationships and link typing which causes the technical effects of reduced memory consumption, increased flexibility and accelerated data retrieval.

FIG. 36, which is intended to be non-limiting, shows a model with data that is obtained from the model in FIG. 33, after an agent has instructed that same embodiment of the system to execute the instructions from FIGS. 34 and 35, followed by the instruction to
create a seventh path, under said first path, that is configured to have as its member all members of said second path for which the numeric value of said second attribute exceeds a first constant value and that inherits, implicitly or explicitly, from said second path
   causing said system to
to execute each instruction successfully and
to create an eighth path under said seventh path that specializes said sixth path and
to create a fifth attribute under said eighth path that is an implementation of said third attribute
   followed by instructing said system to
calculate said third attribute using a formula that returns a second constant value and
calculate said fifth attribute using a formula that returns a third constant value that is different from said second constant value and
set the dominance of said fifth attribute so that it dominates all other implementations of said third attribute and
create a sixth entity under said fourth path and
add said first entity as a target to said fifth path for said sixth entity and
alter the values of said third entity and said fourth entity for said first attribute so that the value of said second attribute for said first entity exceeds said first constant value causing said system to
to execute each instruction successfully and
to create a combined entity with one of its parents being said first entity and the other one of its parents being said sixth entity, under said fifth path and
to return as polymorphic value of said third attribute for said combined entity said third constant value
   indicating that the inference engine and runtime engine of said system supports double dispatch which causes the technical effects of reduced memory consumption, increased flexibility and accelerated data retrieval.

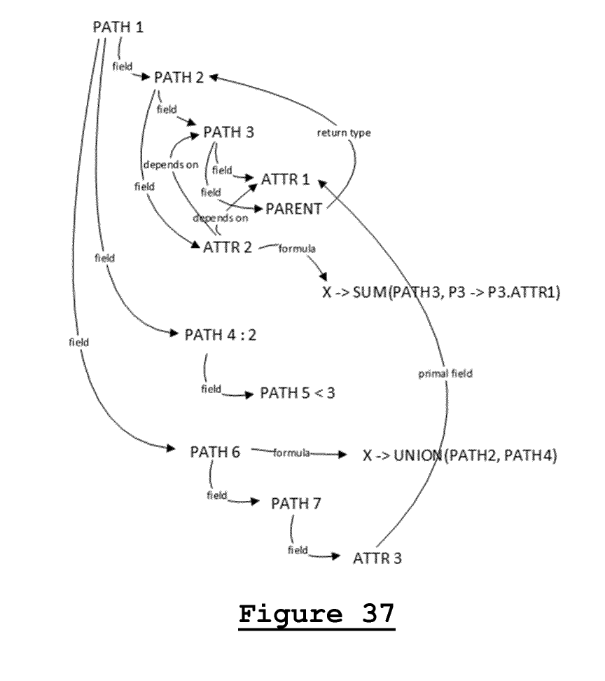

FIG. 37, which is intended to be non-limiting, shows a model with data that is obtained from the model in FIG. 33, after an agent has instructed that same embodiment of the system to
create a fourth path, under said first path, that inherits from said second path
   causing said system to
to execute each instruction successfully and
to create an fifth path, under said fourth path, that is an implementation of said third path
   followed by instructing said system to
create a sixth path, under said first path, associated with a formula that calculates the union of said second path and said fourth path
   causing said system to
to execute each instruction successfully and
to create a seventh path, under said sixth path, that is an implementation of said third path and
to create a third attribute, under said seventh path, that is an implementation of said first attribute
   indicating that the inference engine of said system supports inheritance and union typing which causes the technical effects of reduced memory consumption, increased flexibility and accelerated data retrieval.

Those skilled in the art will appreciate that in these FIGS. 33 to 37, ENTITY 0 has been added to make the figure more in line with the other figures, but the presence is ENTITY 0 is not required for the passing of the tests for support for typed collections, reference fields, calculated fields, native bidirectional relationships, link typing, double dispatch, inheritance and union typing.

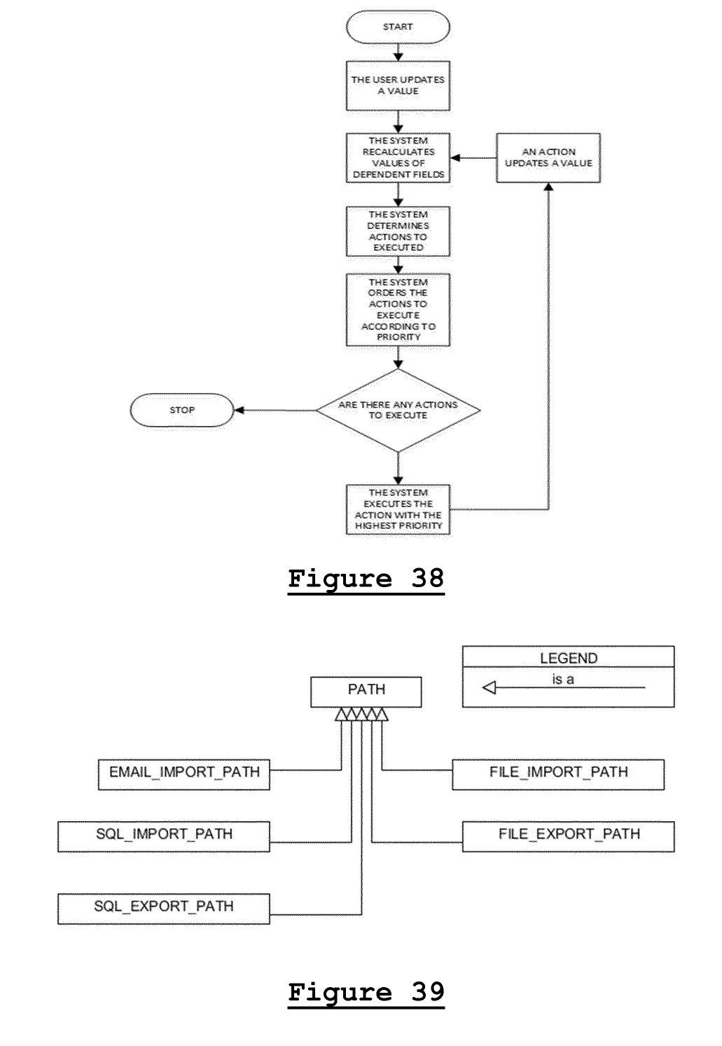

### 5.1.15 Actions (FIG. 38)

According to one preferred embodiment, a path may have, in addition the attribute and sub-path fields, also action fields.

Action fields can be inherited and have inter-life-time polymorphism, just like any other field.

According to a further alternative preferred embodiment of the invention there is provided
a method for executing actions in a data system comprising a storage device and a calculation device; or
a non-transitory computer readable medium embodying information indicative of instructions that when executed by a calculation device in a data system perform said method,
   said method
observing that a key event has occurred, said key event being possibly one of
   an entity entering or existing the extent of a path; or
   the value of an attribute of an entity changing; or
      a user requesting to do so by pressing a key or button that is associated with an entity
      the user making a gesture or any causing any other event that the system can detect and associate with an entity.
performing an action that is associate with said a key event in function of said entity wherein possibly
said action may contain arbitrary code

For example, in some embodiment a piece of C# code that sends an email and an SMS may be attached to the enter event of the path RETIRED_PERSONS. As illustrated in the following model:

```
/DATASETS/PERSONS/AGE
/DATASETS/PERSONS/NAME
/DATASETS/PERSONS/EMAIL_ADDRESS
/DATASETS/PERSONS/TEL_NUMBER
/DATASETS/RETIRED_PERSONS.formula
  =  WHERE(PERSONS,P  ->  P.AGE  >  65)
/DATASETS/RETIRED_PERSONS/CONGRATULATE.formula  =
  =  E  ->  AND(SEND_EMAIL(E.ENTITY.EMAIL_ADDRESS,
            “Happy birthday!”),
        SEND_SMS(E.ENTITY.TEL_NUMBER,
          “Happy  birthday!”))
/DATASETS/RETIRED_PERSONS.onEnter += CONGRATULATE
```

In this example model, the subject “E” passed into the CONGRATULATE action, may be an event, containing the time, location, user, entity and etc. that caused the event, rather than the entity itself. Pieces of C# code and many other languages, can be easily compiled in C# using classes in the .NET System.CodeDom.Compiler namespace.

According to the preferred embodiment, in response to one value changing in the system, multiple key events may occur, scheduling multiple actions to be executed. Those skilled in the art will appreciate that these action correspond to rules in rule based systems and that embodiments may utilize all scheduling techniques known in the art of rule base engines to determine the order in which to execute these actions.

One such technique is to let the user assign a priority to each action. The system then repetitively executes the action with the highest priority and recalculates all updated values caused by said action, possibly skipping actions that have been eliminated. That is, when for an action the change that caused it to activate no longer exists when the action would be executed.

According to a further alternative embodiment of the invention there is provided
a method for performing a plurality of action, each associated with a priority; or
a non-transitory computer readable medium embodying information indicative of instructions that when executed by a calculation device in a data system perform said method,
   said method comprising
performing the action with the highest priority; and
recalculating all updated values caused by said action; and
removing actions that have been deactivate from the actions to be performed.

For example an entity was added to a path and subsequently removed from a path by a previously executed action, the action is said to have been eliminated by the previous action. We said that the action has been “deactivated”.

FIG. 38, which is intended to be non-limiting, illustrates how actions again trigger the recalculation of values in a recursive way according to one at least one embodiment.

According to a further alternative embodiment of the invention there is provided
a method for performing an action in a data system comprising a calculation device and a storage device,
   said action possibly comprising:
sending an email, SMS, SQL instruction or other electronic message to a receiver; or
assigning the value of an attribute to another attribute for an entity; or
creating or deleting an entity; or
opening a file, sending a file, playing a sound, . . . ; or
playing a musical note; or
printing a document; or
instantiating a template by injecting values of fields into a file and adding it to a specified sub-path of the subject, e.g. E->INSTANCIATE_TEMPLATE_AT(E.ENTITY.PARENT.FILE, “@SOME_TARGET_PATH”, File->Replace(File, “$NAME” E.ENTITY.NAME)); or
opening a dialog on an associated display device; or
making a bank payment; or
Etc.

In general these pieces of code have access to the entire API of the data system and all libraries in the .NET framework to perform arbitrary complex tasks.

Those skilled in the art will appreciate that by adding an attribute on the root path that represent the current time or date in the system any time repeating events or planned events can be modelled by calculation, e.g.

```
/DATASETS/DATE_TIME
/DATASETS/PERSONS/BIRTH_DATE
  /DATASETS/RETIRED_PERSONS.formula  =
WHERE(PERSONS,
  P -> YEARS(ROOT.DATE_TIME − P.BIRTH_DATE) > 65)
```

by letting an external process update this time or date on regular intervals. Embodiments may also represent the date as a function, but the technique is the same. Repeating events can be generated by a modulo calculation on time, e.g.

```
    /DATASETS/DATE_TIME
    /DATASETS/NOTES/FREQUENCY
    /DATASETS/NOTES/DURATION
/DATASETS/NOTES/CYCLE_TIME
    /DATASETS/NOTES_TO_PLAY.formula  =
    WHERE(NOTES,
    N -> SECONDS(ROOT.DATE_TIME) %
                      N.CYCLE_TIME = 0)
    /DATASETS/PLAY_NOTE.formula =
        E  ->  PLAY_SINUS(E.ENTITY.DURATION,
            E.ENTITY.FREQUENCY)
```

This illustrates how the system can be used as a time simulation engine and how one particular embodiment of such a time simulation engine is a music generating device.

According to a further alternative embodiment of the invention there is provided
a method for generating music in a data system in a data system comprising a storage device and a calculation device; or
a non-transitory computer readable medium embodying information indicative of instructions that when executed by a calculation device in a data system perform said method,
   said method comprising
generating a sound when an entity enters the extent of a path in function of a variable that represents time increasing
   wherein optionally
said entity has a parent entity; or
said path has a parent path; or
said parent entity is a member of said parent path; or
said system support deep inheritance or any combinations of the other technical features disclosed in this document.

### 5.1.16 API

Preferred embodiments expose and API that is accessible to actions and extern systems comprising of the following:
Methods to create a new entity in an atomic path
Methods to flag en entity as deleted
Methods to manipulate the filter of a derived path
Methods to alter the value of an attribute for a subject
Methods to create and configure new fields
Methods to deactivate fields
Methods to invoice actions
Methods to retrieve the changes the system since that occurred after a specific time
Methods to retrieve the values of fields for subjects
Methods to retrieve the data and meta-data stored in the system
   and so forth. This API is preferable provided in multiple languages such as C#, Java, C++, Java Script, Bash and Python.

### 5.1.17 Materialization

Preferred embodiments allow a user to materialize the values of a calculated field. The calculated values of fields is than stored as the overridden value or the exceptions of a filter of the concerning field. This is handy for schema evolution, by repeatedly materializing calculated fields, schemas can be calculated and materialized into different schema.

### 5.1.18 Joinless Navigation

Those skilled in the art will appreciate that with the disclosed information databases can be built that use dot notation to access attribute of their parents, rather than joins. More specifically, while the parents of an entity can be modelled as foreign keys in a relational database that model a many to one relationship, accessing an attribute from a parent entity would normally require a join, e.g. “SELECT e.COMPANY_ADDRESS FROM EMPLOYEES e INNER JOIN COMPANIES ON e.COMPANY_ID=c.COMPANY_ID”. One of the differences of this invention with these conventional databases is this in embodiment of this invention the join does not need to be specified: e.g. “SELECT x.PARENT.COMPANY_ADDRESS_FROM EMPLOYEES x”. This feature is called “joinless navigation”.

According to a further alternative embodiment of the invention there is provided
a data system comprising a calculation device and a storage devise
   wherein
said data system is capable of navigating to parent entities without performing a join; and
said data system has support for inter-life-time polymorphism.

### 5.1.19 Additional Kinds of Atomic Paths (FIG. 39)

According to one preferred embodiment, data can easily be imported from and exported to external data systems using paths optimized for this. These paths may have multiple formulas to calculate their appropriate settings for each of their subjects. For example, an EMAIL_IMPORT_PATH which is optimized to import email has a formula to calculate
the server to connect to,
the protocol to use and
the credentials to use
   for each subject. An EMAIL_IMPORT_PATH is a kind of atomic path that creates one entity for each email on the server and attaches the various parts of those emails to those entities in the form of values of fields. Similarly, an SQL_IMPORT_PATH is a kind of atomic path and has a formula to calculate
the server to connect to,
the SQL query to use and
the credentials to use
   for each subject. An SQL_IMPORT_PATH creates one entity for each rows returned by the SQL query table and attaches the various column values of rows to those entities in the form of values of fields, it creates one attribute per column returned by the query. An SQL_EXPORT_PATH is a subset path and it adds, deletes, or updates a row for each entity that enters or exits its extent or of which an attribute changes. The user will have to supply formulas to generate to correct SQL to send to the relational database server in response to such entities entering or exiting its extent. Similarly, a FILE_IMPORT_PATH is a kind of atomic path and has a formula to calculate
the server to connect to,
the file system path to connect to,
the credentials to use and
how the files should be filtered based their name and extension for each subject. A FILE_IMPORT_PATH creates one entity for each file that passes said filter under said file system path of said server.

FIG. 39, which is intended to be non-limiting, illustrates how such additional kinds of paths according to one at least one embodiment.

According to a further alternative embodiment of the invention there is provided
a method for importing email under a path in a data system comprising a calculation device and a storage device; or
a non-transitory computer readable medium embodying information indicative of instructions that when executed by a calculation device in a data system perform said method
   said method comprising
polling a server at a regular time interval to test if new email messages have arrived; and
when a new email message has arrived, downloading said email messages and associating it with a new entity under a path in said data system
   said method comprising, in response to said new entity being added to said path
recalculating a value of a field that is dependent on said path; or
performing an action
   wherein
said data system has support for any of the disclosed features.

### 5.1.20 Write Back Formulas

According to one preferred embodiment, many formulas that return scalar values are updatable. For example, the formula “X->X.HEIGHT_IN_CM/1000”, which calculates the height in meter, is a bijection and therefore updating this height in meter can easily be done by updating the underlying height in cm. Similarity, the formulas “X->X.PARENT.HEIGHT_IN_CM/1000” and “X->FIRST(X.EMPOYEES).RIGHT_PARENT.HEIGHT_IN_CM/1000” would update the HEIGHT_IN_CM of the entity that delivered to HEIGHT_IN_CM when asked to update the height in meter, enabling a feature called “writing back into a formula” or in short “formula write-back”. These concepts are known in the prior art as lenses in bidirectional programming systems.

According to a further alternative embodiment of the invention there is provided
a method for writing back a value in to a formula; or
a non-transitory computer readable medium embodying information indicative of instructions that when executed by a calculation device in a data system perform said method
   said method comprising
indicating for each scalar expression that combines two or more scalar sub-expression, in which sub-expression should be written back into, called “the write-back sub-expression”; and
transforming the value to be written back, into a value that is appropriate to be written back into said indicated sub-expression, followed by writing back into said indicated sub-expression
   wherein the algorithm starts with the outer lambda expression of the formula and ends with a triplet comprising the entity, value and attribute to update, e.g. SETVALUE(<ENTITY>, <ATTR>, <VALUE>).

In the case of commutative functions, the write-back sub-expression can be indicated by the order in which the arguments are given, e.g.
“X->X.ATTR1*X.ATTR2” writes-back into ATTR1 while
“X->X.ATTR2*X.ATTR1” writes-back into ATTR2.

For non-commutative functions, the write-back sub-expression can be indicated by the name of the function,
“X->MINUS_{—}1(X.ATTR1, X.ATTR2)” writes-back into ATTR1 while
“X->MINUS_{—}2(X.ATTR1, X.ATTR2)” writes-back into ATTR2,
   or alternatively by including a symbol or visual mark-up into the formula that indicate the write-back sub-expression,
“X->$X.ATTR1$-X.ATTR2” writes-back into ATTR1 while
“X->X.ATTR1-$X.ATTR2$” writes-back into ATTR2.

Only the deepest write-back sub-expression preferably be indicated since the other write-back sub-expressions are indicated by being an ancestors of the said write-back sub-expression.

Finding how to alter the value so that it becomes appropriate for write back into a sub-expression can be found by solving basic algebraic equations. Setting the return value of an expression to y and the sub-expression of the expression to x, z, etc. and solving to the write-back sub-expression, gives the correct transformation:

- X -> X.ATTR1 * $X.ATTR2$ =>
- Y = X.ATTR1 * $X.ATTR2$ =>
- $X.ATTR2$ = Y / X.ATTR1

More general we get:

SETVALUE(X -> $<EXPRESSION1>$ * <EXPRESSION2>,
<X>, <VALUE>) =>
SETVALUE(X -> <EXPRESSION1>,
<X>, <VALUE> / VALUE_OF(<EXPRESSION2>, <X>))

More examples include:

```
-  SETVALUE(X -> $<EXPRESSION1>$ + <EXPRESSION2>,
  <X>, <VALUE>) => SETVALUE(X -> <EXPRESSION1>, <X>,
  <VALUE> - VALUE_OF(<EXPRESSION2>, <X>))
-  SETVALUE(X  ->  $<EXPRESSION1>$  /  <EXPRESSION2>,  <X>,  <VALUE>)  =>
  SETVALUE(X  ->  <EXPRESSION1>,  <X>,  <VALUE>  *
  VALUE_OF(<EXPRESSION2>, <X>))
-  SETVALUE(X  ->  $<EXPRESSION1>$  −  <EXPRESSION2>,  <X>,  <VALUE>)  =>
  SETVALUE(X  ->  <EXPRESSION1,  <X>,  <VALUE>  +
  VALUE_OF(<EXPRESSION2>, <X>))
-  SETVALUE(X -> IF(<EXPRESSION1>, <EXPRESSION2>, <EXPRESSION3>), <X>,
  <VALUE>)  =>  IF VALUE_OF(<EXPRESSION1>,  <X>)  THEN  SETVALUE(X  ->
  <EXPRESSION2>, <X>, <VALUE>) ELSE SETVALUE(X -> <EXPRESSION3>, <X>,
  <VALUE>)
```

Eventually, these kinds of transformations of equations will take us to an equation of the form

```
-  SETVALUE(X -> <EXPRESSION>.<ATTR>, <X>, <VALUE>) =>
  SETVALUE(VALUE_OF(<EXPRESSION>, <X>), <ATTR>,
  <VALUE>)
```

which gives us the triplet we need to update the underlying attribute.

Those skilled in the art will appreciate that although some mathematical functions are not injections, such as POWER, they are near injections and by adding some heuristics, they can be made into injections and thus support the write back feature. For example:
X->POWER(X.ATTR1, 2) is not an injection since for both ATTR1 having the value −2 or 2, the result is 4, and when the user wants to write-back the value 9 into it, it is unclear if the value of ATTR1 should be set to 3 or −3.

But this ambiguity can be solve by adding the heuristic that when the value of ATTR1 is already negative, to should remain negative and vice versa for positive. Taking this heuristic into account the formula for calculating the write back value becomes:

```
-  SETVALUE(X  ->  POW($<EXPRESSION1>$,  <EXPRESSION2>),
  <X>,  <VALUE>) =>  SETVALUE(X  ->  <EXPRESSION1>,
  <X>, IF(VALUE_OF(<EXPRESSION2>, <X>) % 2 == 0,
  SIGN(VALUE_OF(<EXPRESSION1>, <X>)), SIGN(<VALUE>)) *
  ABS(POW(E, (LN(<VALUE>) / VALUE_OF(<EXPRESSION2>,
  <X>))))
```

All other mathematical functions can be inverted in a similar fashion by applying algebraic rules and heuristics.

According to at least one preferred embodiment, the user preferably configures attributes with formulas to either override the calculated value said an attribute upon entering a value for it, or the write-back the value, or to indicate at the time of entering the value which option should be chosen. This indicating may occur by starting the value with an exclamation mark, indicating that the value should be overridden, instead of written back.

Those skilled in the art will appreciate that, besides allowing for very easy conventions between units of measurements, language translations, dates and times, and so forth, this technique also allow the user to have to system lookup the correct entity to update. For example, in the following model:

/DATASETS/CODE
/DATASETS/PRICE.formula
= X -> SINGLE(X.ARTICLES, A -> A.CODE = X.CODE).PRICE
/DATASETS/ARTICLES/PRICE
/DATASETS/ARTICLES/CODE

The price of an article can easily be update by first filling in the code of the article and the writing back its price. This allows entities to function as widgets in that they allow the calculation of navigational state.

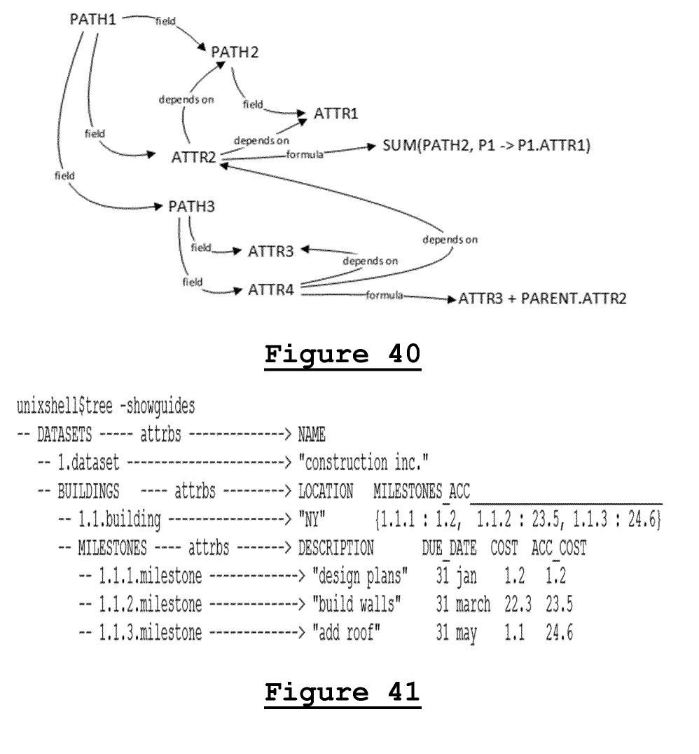

### 5.1.21 Formula Dependency Visualization (FIG. 40)

According to one preferred embodiment, dependencies between formulas can be visually displayed by displaying a graph wherein calculated fields are vertices that are connection through edges with the fields who they reference from within their formulas.

According to at least one preferred embodiment, a method for visualizing a dependency between a first field defined on a first path and a second field defined on a second path in computerized system comprising a display device, comprises
displaying said first field on said display device and
displaying said second field on said display device and
displaying said first path on said display device and
displaying said second path on said display device and
displaying a line that associates said first field with said second field on said display device
   possibly further comprising
displaying a line that associates said first path with its parent path on said display device
   wherein optionally
said system supports deep inheritance and
said system comprises a first entity that is an instance of said first path and a second entity that is an instance of said second path and
said first entity has a parent entity that is a member of the parent path of said first path and
said paths each have at least one renamable attribute and
said dependency is caused by said first field referencing said second field from its associated formula.

FIG. 40, which is intended to be non-limiting, illustrates how the dependencies may be displayed on a display device according to one at least one embodiment.

### 5.1.22 Copy-Paste

According to the preferred embodiment, a method for realizing copy-pasting of an atomic selected entity is employed, said method comprising:
copying said selected entity by
   A. setting said selected entity as the to-be-copied entity
   B. creating a new entity, the copied entity of said selected entity
   C. for each value that said to-be-copied has, copying said value over to said copied entity. Some embodiments may also copy its associated file.
   D. creating a copy of the descendants of the to-be-copied entity by
      creating a new entity for each child of the to-be-copied entity so that
         when the child is atomic, the parent of said new entity should be said copied entity
         when the child is combined, the parent that is said to-be-copied entity should be said copied entity, while the other parent can be taken over
      making said new entity a member of all atomic paths of which said child is a member
      setting said new entity as the to-be-copied entity and back to step B
pasting the copied entity of said atomic selected entity under an atomic path with a subject selected by:
   setting the parent of said copied entity to said subject and making it a member of said atomic path.

### 5.1.23 Loops and Recursion

Some calculations have a recursive nature, for instance: The accumulated cost of a milestone when constructing can be expressed as: the cost of the current milestone augmented with the accumulated cost of the previous milestone.

This causes two problems:
Firstly, it implies that there is an order between entities. So far the entities under a path have been presumed sets, but embodiment may allow the user to specify a natural order of entities under a path by allowing the user to enter in a comparator. For example, the natural order of milestone is ordering them by their due date.
Secondly, it implies that in order to correctly calculate the value of an attribute for a first entity, it may be required that the value for said same attribute must first be calculated for another entity, in other words entities must ‘wait’ for each other. For example, to calculate the accumulated value of entity “1.1.3” in FIG. 41, which is intended to be non-limiting, the accumulated value for entity “1.1.2” must first be calculated.

Said ‘waiting’ cause these calculations to be ill suited for parallel computation optimization techniques. To make matters worse, non-technical user of the system would quickly make mistakes in expression recursive calculations. Also, how these recursive calculations are preformed are crucial for their performance, and non-technical user lack the technical insights to take this into account.

In the preferred embodiment, both issued are solve by the following
Firstly, normal users are not allowed to cause fields to have cyclic dependencies, similar to some embodiments of spreadsheets
Secondly, common known recursive patterns, known in the prior art as “higher order functions” and also “folding”, are built into the system.

One example of such a higher order function, is the built in ACCUMULATE function whose value is an associate array containing all accumulated values.

In FIG. 41, which is intended to be non-limiting, we can see it in operation in the following model:

```
/DATASETS/BUILDINGS/LOCATION
/DATASETS/BUILDINGS/MILESTONES_ACC.formula  =
“X  ->  ACCUMULATE(MILESTONES,
            [ms1  ms2]  -> ms1.DUE_DATE  −  ms2.DUE_DATE,
            MS  ->  MS.COST)”
/DATASETS/BUILDINGS/MILESTONES/DESCRIPTION
/DATASETS/BUILDINGS/MILESTONES/DUE_DATE
/DATASETS/BUILDINGS/MILESTONES/COST
/DATASETS/BUILDINGS/MILESTONES/ACC_COST.formula  =
  “X  ->  PARENT.MILESTONES_ACC[X]”
```

In this model it can be clearly seen how by taking 3 arguments:
a set and
a comparator and
a lambda that return the attribute to accumulate
   the ACCUMULATE function can generate an associative array for each of its subjects, e.g. a building, that may then be used to descendants of said subject, e.g. a milestone, to obtain its accumulated value, e.g. by using itself as a key in said associate array like so “PARENT.MILESTONES_ACC[X]”.

Those skilled in the art will appreciate that loops and recursive patterns are isomorph and that one can be converted into the other, and therefore this is also a way to enable users to loop over the entities under a path.

Those skilled in the art will further appreciate that the entire range of higher order functions known in the art of computing can easily be embedded in embodiments.

According to an further alternative embodiment of the invention there is provided a method that calculates an accumulated value of an accumulation attribute for an entity, e.g. “24.6” of ACC_COST for “1.1.3”, wherein
said accumulation attribute is defined under a path and
said accumulation attribute accumulates over a accumulated attribute defined under said path, e.g. COST
   , said method comprising
calculating for a parent entity of said entity, e.g. entity “1.1”, a value that embodies an associate array for a further attribute, wherein
   said further attribute is defined under the parent path of said path, e.g. said further attribute is MILESTONES_ACC; and
   said further attribute is associated with a formula that references said path and said accumulated attribute; and
   said associate array has
      said entity as one of its keys; and
      said accumulated value as one of its values
calculating said accumulated value of said accumulation attribute for said entity by
   retrieving said associated array from said parent entity; and
   performing a lookup in said associated array by using itself as key in order to retrieve said accumulated value.

Said method allows recursion to be isolated, making said ‘waiting’ issue localized and much less obstructive to parallel execution techniques, execution can thus be optimized. Further it makes the system less error prone and more user friendly.

### 5.1.24 Extra Features

According to a further alternative embodiment of the invention:
files can be streamed from other data systems; or
files attached to entities can be electronically signed, complying with ISO 27001 and meeting the ESIGN Act; or
a web browser plugin can be installed that can adds an entity to a specific path in the data system bookmark, that contains the current URL of the web browser, similar to bookmarks; or
VOIP and chatting functionally is built in; or
Drop box, Ever note, Google drive and Skydrive integration are built in; or
Formulas may use artificial intelligence techniques to calculate their value, e.g. the formula “X->AI_CLASSIFY_IMAGE(X.FILE, X.PARENT.SAMPLES, S->S.FILE, S->S.CLASSIFICATION)” may use a neural net to classify the associated file of an entity based on a set of samples entities that have a file and a correct classification. Frameworks such as ENCOG or WEKA can easily accomplice this; or
attributes may apply OCR to extract their value out of the file that is associated with an entity, this is a subclass of general AI, e.g. the formula “X->AI_GUESS_REGION_TO_ORC_AND_OCR(X.FILE, X.PARENT.SAMPLES, S->S.FILE, S->S.AMOUNT_TO_PAY)” would learn how to extract the salary out of a file, for instance an invoice; or
files are versioned, git can be used to accomplice this; or
versioning of entered data; or
users can choose to hide a field under a path, in that case it will not be displayed in the user interface that is used to inspect an entity, but it is still accessible from within formulas.

### 5.1.25 Overview of Some of the Technical Features of the Invention

A summary of the features that are explained in the section “description of embodiments” and lead to a higher semantical understanding of the user's data by a computing unit, and thus a better performance and a reduction of bugs, are:
Deep inheritance, a feature of data systems wherein when a first field specializes a second field that is a structured type, the first field implicitly inherits from that second field.
Union and intersection typing, a feature of data systems wherein new structured types can be made from the union or intersection of existing structured types such that each field of such a new structured type is associated with multiple fields in the existing structured types that have the same primal field.
Formula inheritance, a feature of data systems wherein structured types inherit implicitly from the inner return types of the formulas that determine their extent.
By-value collections, a feature of data systems wherein entities are associated with collections of other entities that are contained by value. Entities that are contained by value are deleted, when their parent is deleted, in other words: cascade delete is automatic and does not need to be configured for by-value contained entities. By-value collections are a means to support native parent-child relationships.
Typed collections, a feature of data systems wherein a user can add fields to paths, wherein said paths are simply fields who return collections of entities as their value. In such systems, a field which returns a collection serves two purposes simultaneously; identifying a collection of entities for each subject and defining a structured type of which said entities will be instances. This is in strong contrast to conventional systems wherein the user cannot add fields to fields, methods or functions that return collections.
Native bidirectional relationships, a feature of data systems wherein when a user adds a field, whose value for a subject may contain entities that are not-by-value contained by that subject, the data system automatically adds fields to the structured types of which said not-by-value contained entities may be an instance, such that for each such not-by-value contained entity, the user can retrieve all entities that refer to it.
Link instance unification, a feature of a data system wherein combined identities with the same left and right parent, are the same identity and thus have the same value for each of their field for which they have a value. For example, the entity that embodies the employment relationship between a first person and a second person, would also embody the friendship relationship between said same first person and second person. In this way both relations, also called links, are unified.
Link typing, a feature of data systems wherein a user can add fields to a path, wherein said path is a field that returns is a collection and whose targets for its subjects may contain entities that are not-by-value contained by its subject, in such a way that the associations or links that are formed by such a field have said added fields.
Actions, a feature of data systems wherein arbitrary pieces of code may be associated with, and executed on, key events, such as the entry of an entity into the extent of a structured type or the value of an attribute changing, similar to triggers in databases.
Multi-memberships, a feature of data systems wherein entities may be elements of the extent of multiple structured types at the same time.
Volatile fields, a feature of data systems wherein the visual display state of multiple attributes can be calculated with one formula.
Super-positioned memberships, a feature of data systems wherein when an entity is an instance of a first structured type and of a second structured type that inherits from that first structured type and that first structured type has a first field whose value for that entity is a collection of entities and that second structured type has a second field that specializes that first field, than those first and second fields are structured types themselves and each of the elements in that collection are instances of that first and second field.
Deep polymorphism, a feature of data systems wherein the behaviour of the fields of an entity not only depends on the structured type of which that entity is an instance but also on the structured type of which the parent entity of that entity is an instance.
Double dispatch, a feature of data systems wherein the behaviour of the fields of an entity not only depend on the structured type of which that entity is an instance but also on the structured types of which the left parent and right parent entities of that entity are instances.
Inter-life-time polymorphism, a feature of data systems wherein the implementation of a field of an entity is determined by a formula and alters during its life-time. In conventional polymorphism the implementation of a field that is associated with an entity cannot change over its lifetime.
Implementation data-sharing, a feature of data systems wherein the different implementations of a field share parts of the data that they associate with a subject.
Declarative calculated values, a feature of data systems wherein the values of fields may be calculated.
Self-updating aggregates, a feature of data systems wherein the values of field that aggregate over collections of entities recalculate automatically in response to one of their inputs changing.
Document template instantiation, a feature of data systems wherein the values of fields may be injected into files that are associated with entities, called “templates”, in order to create new entities, associated with new files that contain those values of those fields.
Spreadsheet mapping, a feature of data systems wherein the fields of structural types may be associated with cell locations in spreadsheets.
2D mapping, a feature of data systems wherein a first field and a second field of a structural type may be associated with the horizontal and vertical dimensions of a display device.
Table mapping, a feature of data systems wherein the entities of a structural type may be imported or exported from a tabular format consisting of columns and rows, such as tables in relational databases, spreadsheets or CVS files.
Value entitization, a feature of data systems wherein a subset of values that are selected through a formula are converted into entities.
Formula suggesting, a feature of data systems wherein the system can suggest formulas to the user based on the fields that the user has selected.
File system exposability, a feature of data systems that can expose itself as a regular file system.
Joinless navigation, a feature of data systems wherein values of related entities of an entity can be accessed without requiring the user to specify a join.
Formula write-back, a feature of a data systems wherein formulas can not only calculate values, but wherein the values they calculate can be updated, by updating the fields on which the values of those formulas are based.
And several other features, such as user interface related features, transmission of messages, and so forth.

The above list, which is intended to be non-limiting, has been provided to assist the reader to position the invention relative to the existing prior art. The actual features of the invention will be determined by the full disclosure and the scope of the invention should be limited solely by the claims.

Variations of all mentioned embodiments can easily be formed by adding or removing features in the above list.

### 5.2 Options, Additions and Variations of the Disclosed Embodiments and Used Terminology

### 5.2.1 Additional Embodiments

The data structures that represent the meta-data and data of applications are also disclosed here, and thus embodiments of the invention, more specifically, one specific embodiment is a non-transitory computer readable medium embodying a data system comprising:
a first path and
a second path, under said first path and
a first field, under said second path
   possibly further comprising:
a third path that inherits from said first path and
a second field, under said third path, that specialises said first field
   possibly further comprising:
a first entity that is a member of said first path
a second entity that is a member of said second path and a child entity of said first entity
said second entity has two parents
a value that is that value of said first field for said second entity
   wherein possibly:
said first field is associate with a first formula
said second field is associated with a second formula that overrides said first formula
said first field is an attribute
said first field is a path with one attribute under it
said paths and attribute are renamable
said first field is an attribute and associated with a spreadsheet cell position
said first field is an attribute and associated with a table column

Another embodiment is a data system
stored on a non-transitory computer readable medium or
comprising of a calculation device and a storage device
   , said data system comprising
at least one path that is
   a structured type, in other words said path has fields and
   a field itself, in other words said path associates values with certain entities
      potentially comprising further
a second path that inherits from said first path or
a reference field under said path, said reference field's return type being the parent path of said path
   wherein optionally
entities can have one or two or more parents

Another embodiment is a method for generating specialized fields, under a path, in response to a user adding a base path to said path by
creating a new field under said path for each field under the base path of said base path, each said new field specializing its corresponding field under said base path.
for each new field that is a path, adding the field that it specializes, that thus also will be a path, to its base paths and generating its specialized fields.

This method is vital in order to realize deep inheritance, which enables super positioned memberships, reducing bugs and memory consumption while increasing flexibility.

Variations of all mentioned embodiments, include embodiments wherein
at least one attribute is associated with a cell in a spreadsheet or
entities are files or associated with files and paths are folders or tags or
entities are programming object and paths are classes or
at least one attribute is renamable at runtime or
multiple attributes are renamable at runtime or
calculating the current paths of an entity comprises first calculating the current paths of the ancestors of said entity because the current paths of the ancestors of an entity may affect its own current paths, a feature called super positioned memberships or
said system has support for link typing or
said system has support for deep inheritance or
calculating the current fields of an entity comprises calculating the current paths of the entity first, because entities may be in multiple paths at the same time, a feature called multi-memberships or
at least one attribute is associated with a spreadsheet cell position
the embodiment contains or executes instructions that embody deep inheritance behaviour and are executable by a calculation device; the presence of said instructions can be confirmed by
   adding a first added path followed by
   adding a second added path, under said first added path followed by
   adding a first added attribute, under second added path followed by
   adding a third added path, that inherits from said first added path followed by
   verifying that said third added path now has a path that has an attribute that specializes said first added attribute
the embodiment contains or executes instructions that embody super positioned memberships behaviour and are executable by a calculation device; the presence of said instructions can be confirmed by
   adding a first added path followed by
   adding a second added path, under said first added path followed by
   adding a third added path followed by
   adding a fourth added path, that is an implementation of said second added path, under said third added path followed by
   adding a first added entity, as a member of said first added path followed by
   adding a second added entity, that is a descendent entity of said first added entity and is a member of said second added path followed by
   adding said first added entity as a member of said third added path followed by
   verifying that said second added entity is now also a member of said fourth path and thus confirming the presence of said instructions
wherein optionally
   said fourth added is added as a consequence of said third path inheriting from said first path.
the embodiment contains or executes instructions that embody link typing behaviour and are executable by a calculation device; the presence of said instructions can be confirmed by
   adding a first added path followed by
   adding a second added path followed by
   adding a third added path followed by
   adding a first added attribute, under said third added path followed by
   adding a first added entity, as a member of said first added path followed by
   adding a second added entity, as a member of said second added path followed by
   adding a third added entity that has as its parent entities said first added entity and said second added entity, as a member of said third added path, and thus confirming the presence of said instructions
wherein optionally
   only entities that have a first parent that is a members of said first path and have a second parent that is a member of said second path can be added to said third path.
the embodiment contains or executes instructions that embody multi-memberships behaviour and are executable by a calculation device; the presence of said instructions can be confirmed by
   adding a first added path followed by
   adding a second added path followed by
   adding first added entity, as a member of said first added path and said second added path, and thus confirming the presence of said instructions
the embodiment contains or executes instructions that embody spreadsheet mapping behaviour and are executable by a calculation device; the presence of said instructions can be confirmed by
   adding a first added path followed by
   adding a first added attribute, that is associated with a first spreadsheet cell position, under said first added path followed by
   adding a second added attribute, that is associated with a second spreadsheet cell position and
      a formula that configures the system to calculate its value as twice the value of said first added attribute for each entity, under said first added path followed by
   adding a first added entity, as a member of said first added path followed by
   adding a second added entity, as a member of said first added path followed by
   setting a first value as the value of said first added attribute of said first added entity followed by
   setting a second value as the value of said second added attribute of said second added entity followed by
   verifying that said first added entity has an first associate spreadsheet whose value for said second spreadsheet cell position is twice the value of said first value and said second added entity has a second associate spreadsheet whose value for said second spreadsheet cell position is twice the value of said second value, thus confirming the presence of said instructions.
      and all of their combinations.

Adding an entity, path or field should be interpreted broadly as “performing any sequence actions that 1) causes the addition of said entity, path or field and 2) realizes all stated conditions”. So for example, “adding an entity under a path” could be comprised of altering the value of an attribute of said entity, if that path is calculated and uses said attribute to determine its extent. So the actual addition of said entity, path or field may occur by the system as a consequence of the user's actions.

Further variations of embodiments are implied by embodiments that embody a method. That is any embodiment that embodies a method, implies the following alternative embodiments:
A non-transitory computer readable medium embodying information indicative of computer executable instructions that when executed by a calculation device perform said method or
A node in a data system embodied as a client-server architecture or peer-to-peer architecture, said node comprising a storage device, a calculation device and a communication device suited for network communication, said data system executing said method or
A type inference system comprising a storage device and calculation device executing said method or
Any hardware component of a data system, said data system comprising a storage device, a calculation device and a display device as hardware components and configured to execute said method.

### Any

non-transitory computer readable medium embodying information indicative of instructions that are executable by a calculation device in a data system,
type inference system comprising a storage device and a calculation device executing instructions
data system comprising a storage device and a calculation device executing instructions
method for managing data embodied by executing instructions in a data system comprising a calculation device and a storage device
   with said instruction comprising
instructions that enable native parent-child relationships and structured sets or
instructions that enable multi-memberships or
instructions that enable inheritance or
instructions that enable native bidirectional relationships or
instructions that enable link typing or
instructions that enable volatile fields or
instructions that enable super-positioned membership or
instructions that enable calculated values or
instructions that enable formula generation or
instructions that enable actions or
instructions that enable self-updating aggregates or
instructions that enable deep inheritance or
instructions that enable deep polymorphism or
instructions that enable double dispatch or
instructions that enable inter-life-time polymorphism or
instructions that enable derived inheritance or
instructions that enable union and intersection typing or
instructions that enable implementation data-sharing or
instructions that enable value entitization or
instructions that enable template generation or
instructions that enable spreadsheet mapping or
instructions that enable 2D mapping or
instructions that enable table mapping
   or any combinations thereof, wherein possibly
the attributes in said system are renamable at runtime
   are embodiments of the invention.

According to a further alternative embodiment of the invention there is provided
a method for recalculating a first value of a first field for an first entity in an automated fashion in response to a user altering a second value of a second field of a second entity on which said field is dependent; or
a non-transitory computer readable medium embodying information indicative of computer executable instructions that when executed by a calculation device perform said method,
   said method comprising
recalculating said first value for of said first field for said first entity in an automated fashion in response to a user altering a value of an attribute, similar to a spreadsheet.

In variations of said method, said data system further comprises a computing node connected to a display device and said method further comprises
sending a message to said computing node; and
updating said display device
   wherein possibly
said second field is used in function of calculating said first field; or
a further user of said data system is logged in at said computing node

### 5.2.2 Extentions and Additions

All extensions and additions as described in the U.S. patent application Ser. No. 13/736,646 filed Jan. 8, 2013 apply to this invention as well.

### 5.2.3 Variations on the Presented Algorithms, Diagrams and Data Structures

Those skilled in the art will appreciate that the expressions and description of algorithms and data structured included herein may be modified by alternating between different ways of how data is stored in a non-transitory computer readable medium, how it is associated with each other and how computer instructions are made to execute conditionally, as is common in art of computer programming. Some of these variations, by way of example and not limiting, include executing code conditionally though switch-cases; polymorphic calls; branching instructions, associating two computing entities though pointers; data structures such as arrays; lists; hash sets; associative arrays; trees; heaps; transitivity by dereferencing multiple pointers or data-structures sequentially; keys encoded in strings; integers or combination of integers, transforming code through in-lining code; moving conditional code outside of loops; optimization techniques; introducing functions with parameters; moving conditional code outside of loops; replacing loops by recursive functions and vice versa and other compiler techniques.

Further, the fact that an element is contained in a set (such as a path) may be expressed as a boolean value associated with each element that may be contained in that set: if its value is true, than the element belongs to the set, if it is false, than it does not. These two representations are equivalent and form an index over one another; a set is simply a faster way to find all elements whose boolean value is true and a boolean is simply a faster way to check if the element is contained in the set. Similarly, each value of an enumeration has an associated set. This is why, as noted above, paths may be understood as boolean attributes of entities that model their membership. If its value is true, than the entity is a member of the path, if it is false then it is not. Some embodiments may choose to include entities for which the value is unknown, other may exclude those files. This value may be calculated or not.

Other changes in representations that may be applied to the above description include changes in the order of steps that are not dependent on each other, using subclasses, or adding extra fields to a class. These and a multitude of various techniques can be employed by any programmer skilled in the arts to make various variations of the same algorithm or system. All programming samples, diagrams and disclosed algorithms provided in this document represent their present form, as well as all variations that may be formed from them by using the above mentioned techniques.

### 5.2.4 Non-Limiting Examples and Explanation of Terminology Used Above

For practical reasons, the above description describes the invention by using certain terms that will be understood by those skilled in the art to have a broader meaning in the context of the invention.

For example, the invention is intended to apply to objects and other data entities rather than just ‘files.’ When the invention is used with empty files, it may be considered to be a system for working with objects in an adapted object oriented system. Further, “being” a file, or being “associated” with one, can be considered equivalent. Alternatively, all files may be replaced with objects with one extra field containing the data in the file. This is why the current invention can be seen as a file system or an object management system. Indeed, files can be seen as objects, and paths can be seen as a new kind of dynamic classes of these objects.

Examples of generally known output devices optimized for human receivers are:
a sound generating device, such as for example earplugs or speakers, . . .
a display device, such as a computer display, laptop display, tablet display, smartphone display, watch display, projector, eye lens or contact lens display device, which is a device optimized to be worn on the surface of the eye of a human being, eyeglass display, which is a display device optimized to be worn in front the eye of a human being, etc.

Examples of generally known output devices optimized for non-human receivers, such as for clients or servers or standalone computing devices, are a Modem, USB port, Serial port, Parallel port, Ethernet port, optical port, wireless communication device, any other electrical based communication device, any other Light based carrier communication device, etc.

Examples of generally known input devices for capturing human generated input are a sound input device such as for example a microphone, touch input device such as for example a touchscreen or touch pad; pointer input device such as for example:
a mouse,
an eye motion tracking device,
a computer vision device, for example a body motion tracking device; and
a neural communication device which is a device optimized to interact directly with the brain of a human, etc.

Examples of generally known input devices optimized for capturing input generated by a non-human are a modem, USB port, Serial port, Parallel port, Ethernet port, Optical port, wireless communication device, any other electrical based communication device, any other light based carrier communication device, etc.

Examples of generally known calculating devices are: a central processing unit (CPU), a desktop computer, a laptop, a web browser application, a watch, a smartphone, a tablet computer, etc.

Examples of an entity are for example a file, an object oriented data structure, database records, etc.

According to various embodiments, the set of data entities contained in an extent may be different in different contexts. The context, which may for example be the current opened data set, the current user, the current version or any other suitable selectable information, enables the current content of the extent to be uniquely identified. According to such an embodiment the entity properties and type properties have suitable values for each of the available contexts.

Those skilled in the art will appreciate that in general, the value of an attribute is a concrete value such as a number, a text, a boolean, a file, a date, a matrix or any other structured value, similar to the concept of value type in C#. However, some embodiments may also allow the value of an attribute to be UNKNOWN or NULL, a default value, or a default value configured per attribute, and that these special values are thus also values.

When referring to a subset in the description, the term ‘subset’ is used in the following sense: a first set is a subset of a second set when said first set contains between zero and all elements of said second set and said first set does not contain any elements not contained by said second set.

Those skilled in the art will appreciate that the navigational state of a program is that part of the internal state of the program that influences the subset of data that is being displayed by an associated display device. A navigational state is often reached by repeatedly instructing the program to display the details of a data entity, by selecting said data entity.

Those skilled in the art will further appreciate that the term ‘storage device’ encompasses any piece of hardware capable of storing data for an amount of time, including but not limited to a hard disk, a transistor based memory, a capacitor based memory, a RAM memory, flash disks, qubit based and so on.

Those skilled in the art will further appreciate that the term “sending a message” is to be interpreted as broadly as performing any action that will lead to the receiving party in the near future obtaining the message. Thus, cases where the receive party is polling for messages to circumvent NAT networks, or any other techniques to overcome common communication problems such as firewalls and dynamic IP addresses that are known in the prior and future art, are to be interpreted as the sending party sending a message to the receiving party.

Having thus described preferred embodiments of the invention in connection with the accompanying drawings, it will be appreciated that the invention is not to be limited to the specific embodiments or variations disclosed, but rather should be limited solely by the appended claims.

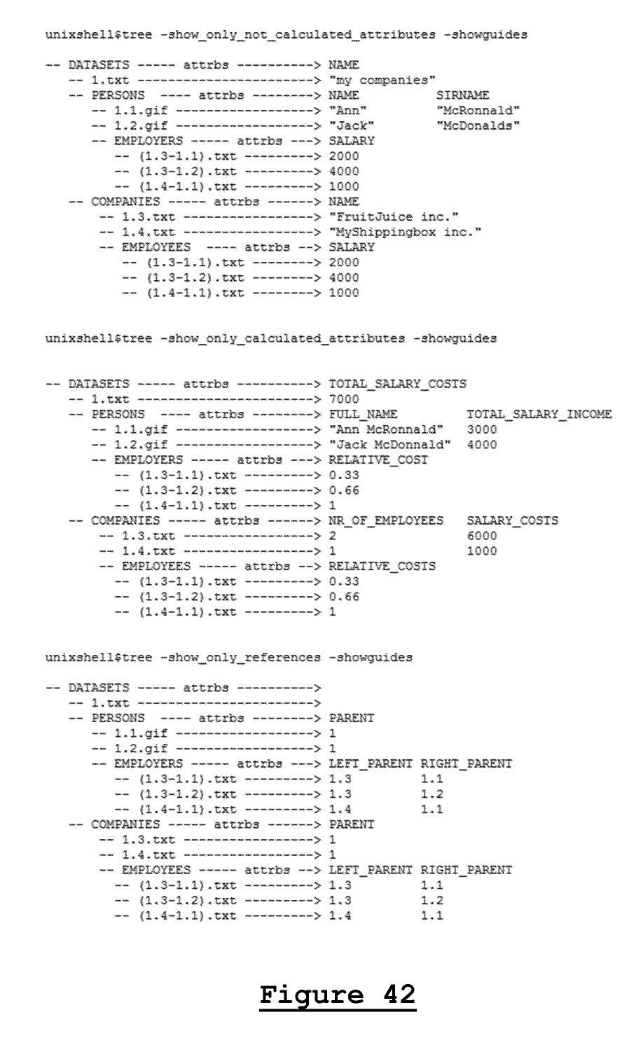

### 5.3 Further Examples (FIGS. 42-45)

FIG. 42, which is intended to be non-limiting, illustrates in tree snapshots of one application, the inputted data of that application, the references in the application and the derived values, supposing the formulas of that attributes TOTAL_SALARY_COSTS, FULL_NAME, TOTAL_SALARY_INCOME, RELATIVE_COST, NR_OF_EMPLOYEES and SALARY_COST are

```
-  TOTAL_SALARY_COSTS.formula = SUM(COMPANIES,
  C -> C.SALARY_COSTS)
-  FULL_NAME.formula = CONCAT(NAME, SIRNAME)
-  TOTAL_SALARY_INCOME.formula = SUM(EMPLOYERS,
  E -> E.SALARY)
-  RELATIVE_COST.formula = SALARY /
-  LEFT_PARENT.SALARY_COST
-  NR_OF_EMPLOYEES = COUNT(EMPLOYEES)
-  SALARY_COST.formula = SUM(EMPLOYEES, E -> E.SALARY)
```

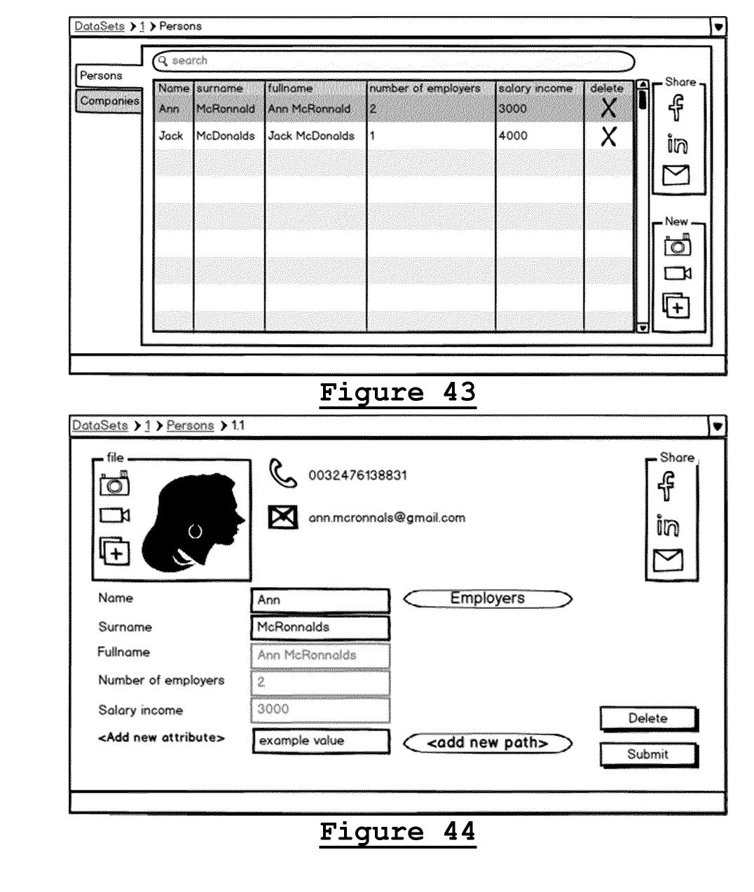

FIGS. 43 and 44, which are intended to be non-limiting, illustrate one graphical user interface of a similar application wherein entities and their fields can be referenced though an URL and integration with social media such as Facebook and LinkedIn and calling, messaging, sharing, taking pictures and other popular facilities are provided. For example taking a picture while on the screen in FIG. 43 may add a new person, and navigate to it, with that picture as its file. In FIG. 44 it is illustrated how the user can add new path and fields immediately though the user interface. Clicking on the path Employers may bring the user to a screen similar to 43 but with a different URL.

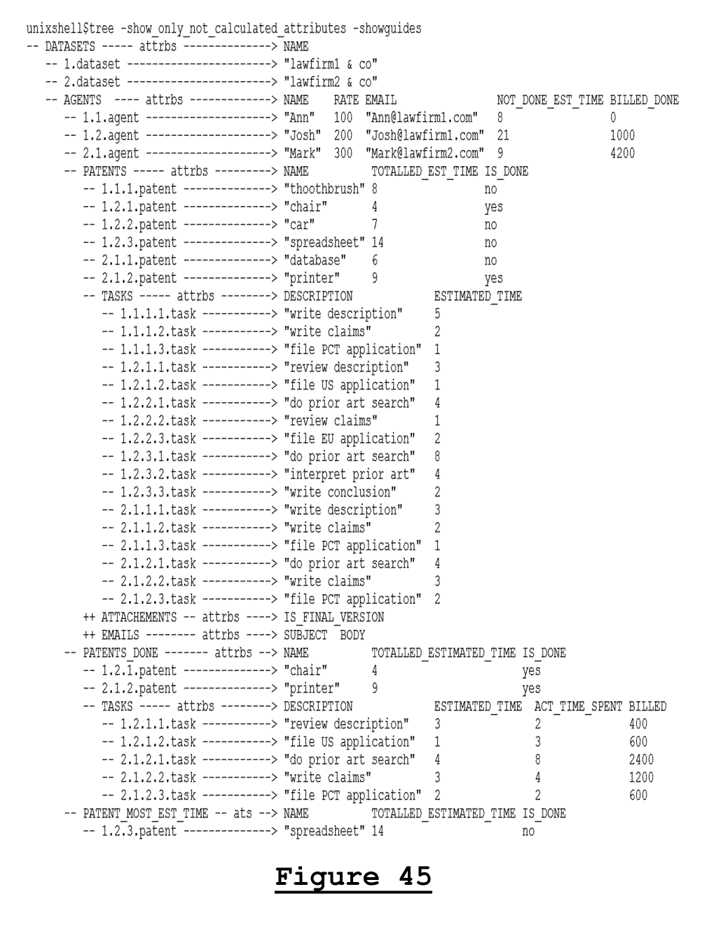

FIG. 45, which is intended to be non-limiting, illustrate one graphical user interface of an application that could be used to manage on-going patent application by patent agents. The used formulas in said model are

```
/DATASETS/AGENTS/NOT_DONE_EST_TIME.formula =
  “SUM(WHERE(PATENTS, P -> !P.IS_DONE),
    P -> P.TOTALLED_EST_TIME)”
/DATASETS/AGENTS/BILLED_DONE.formula=
  “SUM(SELECT_MANY(PATENTS_DONE, P -> P.TASKS),
  T -> T.BILLED)”
/DATASETS/AGENTS/PATENTS/TOTALLED_EST_TIME.formula =
  “SUM(TASKS, T -> T.ESTIMATED_TIME)”
/DATASETS/AGENTS/PATENTS_DONE.formula=
  “WHERE(PATENTS, P -> P.IS_DONE)”
/DATASETS/AGENTS/PATENTS_DONE/TASKS/BILLED.formula =
  “ACT_SPENT_TIME * PARENT.PARENT.RATE”
/DATASETS/AGENTS/PATENTS_MOST_EST_TIME.formula =
  “FIRST(ORDER_BY_DESCENDING(PATENTS,
              P -> TOTALLED_EST_TIME))”
```

and the inheritance relationships between PATENTS, PATENT_DONE and PATENTS/TASKS and PATENT_DONE/TASKS can be clearly seen from the repetition of attributes.

One embodiment of the invention is
a method for forming a URL for accessing an entity in a data system or
a non-transitory computer readable medium embodying information indicative of computer executable instructions that when executed by a calculation device execute a method for forming a URL for accessing an entity in said data system
   , said method comprising of
initializing a string followed by
concatenating an identifier of a first path to said string followed by
concatenating an identifier of a first entity to said string followed by
concatenating an identifier of a second path to said string followed by
concatenating an identifier of a second entity to said string, forming said URL
   wherein
said second path is a sub-path of said first path
said second entity is a descendent of said first entity
said second entity is a member of said second path
said first entity is a member of said first path
the identity of said second entity comprises the identity of said first entity.

An example of such a URL is shown in FIG. 43, e.g. DataSets/1/Persons/1.1

Those skilled in the art will appreciate that preferred embodiments may offer different views for the same application, based on the device by which the user is interacting with the system or the user itself, e.g. pc, television, tablet, smartphone, watch, glasses, lenses etc. Besides having localized user-friendly names for all paths and fields and potentially hiding or showing fields based on the logged in user, also the structure of the user interface may be different.

Having thus described preferred embodiments of the invention in connection with the accompanying drawings, it will be appreciated that the invention is not to be limited to the specific embodiments or variations disclosed, but rather should be limited solely by the appended claims.

The following books accompany this disclosure:
Engineering a Compiler, Second Edition, ISBN-13:978-0120884780;
Semantics, Second Edition, ISBN-13: 978-0230232303;
An Introduction to Functional Programming Through Lambda Calculus, ISBN-13: 978-0486478838; and
An Introduction to Parallel Programming, ISBN-13: 978-0123742605

1. A method for calculating the value of a first path of a first entity in a data system comprising a calculation device and a storage device with said first path stored thereon, said method comprising the step of said calculation device calculating said value as all entities:
that are descendants of said first entity; and
that are members of said first path.

2.-6. (canceled)

7. The method according to claim 1, further comprising
calculating the members of said first path by means of an associated formula, said formula utilizing values of a first attribute under a further path defined in said data system.

8. The method according to claim 7, further comprising
displaying said value of said first attribute as a value of a cell in a spreadsheet

9. (canceled)

10. The method according to claim 7, wherein
said first attribute or said first path comprises a human readable identifier which is modifiable
said human readable identifier is modifiable at runtime, so that if said human readable identifier is modified by a first user, than a second user can see the new value of said human readable identifier without needing to login again in said data system.

11. The method according to claim 7, wherein said first path inherits an attribute from a further path.

12. The method according to claim 7, wherein said formula references a second path that:
is a sub-path of the parent path of said first path; and
comprising a reference field whose return type is the parent path of said first path.

13. The method according to claim 7, further comprising
calculating a dominant implementation for at least one of said descendants of said entity, in order to calculate the members of said first path.

14. The method according to claim 1, further comprising
calculating for at least one of said descendants of said entity, referred to as subject, a polymorphic value for a derived primal path's implementation by:
determining the primal field's dominant current implementation of said subject;
calculating said polymorphic value as the non-polymorphic value for that dominant implementation of said subject by calculating the subject's targets for that dominant implementation by filtering its formula targets with its filter for said subject, and when the path is a link path, creating or locating for each obtained target a new or existing combined identity with as its left parent said subject and as its right parent said target, wherein a subject's formula targets and filter for a derived path implementation are respectively:
the entities obtained by applying the implementation's formula to the subject and
a filter that the user can configure by setting its default rule to pass or block all possible targets and by adding exceptions to that default rule,
in order to calculate the members of said first path in function of said polymorphic value.

15. The method according to claim 1, further comprising
calculating exceptions in a filter associated with at least one of said descendent entities for
a derived path by
determining the exceptions in the filters of the source implementations of said derived path for said one descendent entity
calculating the exceptions in the filter associated with said one descendent entity for said derived path as
the intersection of the exceptions in said filters source implementations, in order to calculate the members of said first path.

16. The method according to claim 7, further comprising
extracting a number out of a file that is associated with one of said descendent entities by:
locating said associated file
opening said file
reading bytes from said file
interpreting said bytes as a number,
in order to calculate the members of said first path.

17. The method according to claim 1, further comprising
calculating for at least one of said descendants of said entity, referred to as subject, a value for a primal attribute's implementation of said subject by
calculating the primal field's dominant current implementation of said subject
calculating said subject's formula value for that dominant implementation
calculating said subject's value for that dominant implementation as said formula value or its overridden value,
wherein a subject's formula value and overridden value for an attribute implementation are respectfully:
the value obtained by applying the implementation's formula to said subject and
an independent value that may be provided by the user that overrides the formula value of a subject,
in order to calculate the members of said first path.

18. The method according to claim 7, further comprising
retrieving a value from column in relational database,
said column being associated with an attribute under a sub-path of the parent path of said first path, in order to calculate the members of said first path.

19. The method according to claim 7, wherein
said entities are files or associated with files and said paths are folders or tags.

20. (canceled)

21. The method according to claim 1, wherein
said entities are programming objects and said paths are classes.

22. The method according to claim 7, wherein
at least one of said descendent entities is a member of at least two paths.

23. A method according to claim 1, wherein said first path has reference fields that have been calculated at an earlier point in time by:
calculating the reference fields of said first path
calculating the non-reference field of said path
calculating the fields of a first path as the union of the reference fields and none-reference fields of said path.

24. The method according to claim 5, wherein
when said first path is atomic; then
under said first path is a parent field whose return type is the parent path of that path.

25. The method according to claim 5, wherein
when said first path is a sub-set path; then
under said first path is a proxy field, for each reference field in the inner return type of said path's associated formula.

26. The method according to claim 5, wherein
under said first path is a specialized field, for one of the none-reference fields in the inner return type of said path's associated formula

27. The method according to claim 7, wherein
the return type of the outer scope variable of said associated formula is the parent path of said first path

28. The method according to claim 7, wherein the return type of a field expression that:
is embedded in said associated formula; and
references to a further field,
has been previously calculated as the return type of said further field.

29. The method according to claim 1, wherein said associated formula contains a UNION function whose return type is a set type whose inner type is an or-fashioned multi-structured type, the or-fashioned multi-structured type comprising as its components the inner return types of at least two arguments of said UNION function.

30. The method according to claim 29, wherein the fields of said or-fashioned multi-structured type, have been previously calculated by grouping the fields of its components by their primal fields.

31. The method according to claim 30, said calculating of said fields of said or-fashioned multi-structured type further comprising:
creating for each such by-primal-field-grouping one specialized field that specializes said by-primal-field-grouping

32. (canceled)

33. The method according to claim 7, wherein, when said first path is a link path, said first path has a left and right parent field under it, that have been calculated at an earlier time by:
creating a left parent field under said path, whose return type is the parent path of that path; and
creating a right parent field under said path, whose return type is the inner return type of an associated formula of said first path

34. The method according to claim 7, wherein when said first path is a back-link path, said first path's left and right parent fields where created by calculation at a previous time, said calculation comprising:
creating a left parent field under said first path, whose return type is the parent path of said first path's primal link-path; and
creating a right parent field under said first path, whose return type is the parent path of said first path

35. The method according to claim 7, wherein
a root field under said first path is present; and
said root field's return type is the root path of the model.

36. The method according to claim 7, wherein said first path has a primal field.

37. The method according to claim 7, wherein said first path has a specialized field that specializes at least one field of all the fields under the base paths of said first path.

38. (canceled)

39. The method according to claim 7, wherein
said first path has a specialized field that is associated with a group of fields; and
said group of fields, groups the fields under the base paths of said first paths by their primal field.

40. (canceled)

41. The method according to claim 50, wherein said data system further comprises a computing node connected to a display device, said method further comprising
sending a message to said computing node; and
updating said display device

42.-45. (canceled)

46. A method for calculating the content of a first folder of a first file in a data system comprising a calculation device and a storage device with said first folder stored thereon, said method comprising the step of said calculation device calculating said content as all files:
that are children of said first file; and
that are contained by said first folder.

47. The method according to claim 46, wherein said folders have fields so that:
each file in a folder has a value for each field defined on that folder; and
subfolders of folders can also be seen as fields and their value for a given file is a set of files.

48. The method according to claim 47, further comprising
recalculating content of said first folder in an automated fashion in response to a user altering the value of an attribute on which said folder's formula is dependent.

49. The method according to claim 1, further comprising
recalculating said members of said first path in an automated fashion in response to a user altering a value of an attribute on which said first path is dependent

50. The method according to claim 7, further comprising
recalculating said members of said first path in an automated fashion in response to a user altering a value of an attribute on which said first path is dependent

51. The method according to claim 10, further comprising
recalculating said members of said first path in an automated fashion in response to a user altering a value of an attribute on which said first path is dependent

52. The method according to claim 12, further comprising
recalculating said members of said first path in an automated fashion in response to a user altering a value of an attribute on which said first path is dependent

53. The method according to claim 16, further comprising
recalculating said members of said first path in an automated fashion in response to a user altering a value of an attribute on which said first path is dependent

54. The method according to claim 19, further comprising
recalculating said members of said first path in an automated fashion in response to a user altering a value of an attribute on which said first path is dependent

55. An apparatus in relation with the method according to claim 7, said apparatus and relation being:
a non-transitory computer readable medium embodying information indicative of computer executable instructions, that when executed by a calculation device, can be used to perform the method according to claim 7; or
a node participating in a client-server or peer-to-peer architecture forming a data system performing the method according to claim 7; or.
a data system comprising a calculation device and a storage device, said data system configured to perform the method according to claim 7.

56. An apparatus in relation with the method according to claim 54, said apparatus and relation being:
a non-transitory computer readable medium embodying information indicative of computer executable instructions, that when executed by a calculation device, can be used to perform the method according to claim 54; or
a node participating in a client-server or peer-to-peer architecture forming a data system performing the method according to claim 54; or.
a data system comprising a calculation device and a storage device, said data system configured to perform the method according to claim 54.

57. A non-transitory computer readable medium embodying information indicative of computer executable instructions embodying a method that creates a new class in response to a user declaring a field, whose return type is a collection type, on an existing class, in order to let said user create new fields on said newly created class.

58. The apparatus according to claim 57, wherein further
said method is part of a tool suitable for general purpose calculation or workflow; and
say tool recalculates, in an automated fashion, the result of a formula when any of the values of the fields on which the formula is dependent changed.

59. The apparatus according to claim 58, wherein further
said tool supports multi-memberships.

60. The apparatus according to claim 59, wherein further
said classes are displayed to the user as folders of a file system.

61. A computer readable medium embodying information indicative of computer executable instructions embodying a method of displaying, by means of a tree widget, the files and folders present in the variation of a conventional file system, said method comprising
when in said tree widget a folder gets expanded, displaying file names under the name of said expanded folder; and
when in said tree widget a file gets expanded, displaying folder names under the name of said expanded file,
wherein said displayed folder names are the names of the subfolders of the folder in which said expanded file resides.

62. The apparatus according to claim 61, wherein further
said file has a parent file; and
said file has a numeric field; and
said parent file has a numeric field whose value is configured to be the sum of the values of said numeric field for all files that
are child files of said parent file; and
reside in the same folder as said file.
